(19) United States
(12) Patent Application Publication
(10) Pub. No.: US 2026/0147081 A1
(43) Pub. Date: May 28, 2026

(54) MINIMUM DESCRIPTION FEATURE SELECTION FOR COMPLEXITY REDUCTION IN MACHINE LEARNING-BASED WIRELESS POSITIONING

(71) Applicants: Purdue Research Foundation, West Lafayette, IN (US); University of Kansas, Lawrence, KS (US)

(72) Inventors: Christopher Greg Brinton, West Lafayette, IN (US); Anindya Bijoy Das, Stow, OH (US); Taejoon Kim, Chandler, AZ (US); David J. Love, West Lafayette, IN (US); Myeung Suk Oh, Columbus, OH (US)

(73) Assignees: Purdue Research Foundation, West Lafayette, IN (US); University of Kansas, Lawrence, KS (US)

(21) Appl. No.: 19/394,965

(22) Filed: Nov. 20, 2025

Related U.S. Application Data
(60) Provisional application No. 63/723,965, filed on Nov. 22, 2024.

(51) Int. Cl. G01S 5/02; G06N 3/0464

(52) U.S. Cl. CPC G01S 5/0268; G06N 3/0464

(57) ABSTRACT

A system and method for wireless positioning incorporates positioning neural network that utilizes low-dimensional features in mobile settings. The low-dimensional features are, in particular, a minimum description feature set that comprises a predetermined number of largest power measurements and their temporal positions. For robust performance against various channel conditions, the predetermined feature size is adaptively selected by jointly optimizing over the expected amount of information and classification capability, quantified through information-theoretic measures.

This application claims the benefit of priority of U.S. provisional application Ser. No. 63/723,965, filed on Nov. 22, 2024 the disclosure of which is herein incorporated by reference in its entirety.

### GOVERNMENT LICENSE RIGHTS

This invention was made with government support under ECC 1941529, CNS 2225578, CNS 2225577, CNS 2212565, CNS 2146171 awarded by the National Science Foundation. The government has certain rights in the invention.

### FIELD

The devices and methods disclosed in this document relate to wireless positioning and, more particularly, to minimum description feature selection for complexity reduction in machine learning-based wireless positioning.

### BACKGROUND

Unless otherwise indicated herein, the materials described in this section are not admitted to be the prior art by inclusion in this section.

Recently, deep learning approaches have provided solutions to difficult problems in wireless positioning (WP). Although these WP algorithms have attained excellent and consistent performance against complex channel environments, the computational complexity coming from processing high-dimensional features can be prohibitive for mobile applications.

An abundance of today's mobile systems rely on the ability of devices to perceive and locate their surroundings. Popular examples include object localization in autonomous vehicles, robotics, and unmanned aerial vehicles (UAVs), as well as many other Internet of Things (IoT) use-cases. Given the prevalence of wireless sensors in these systems, wireless positioning (WP) has become a commonly investigated technique for providing situational awareness in mobile applications.

WP is typically conducted using a group of wireless sensors that exchange signals with a target of interest in order to collect measurements that are informative for location estimation. These sensors form a network, and the measurements from each sensor are collected by a data fusion center (DFC) for centralized processing to estimate the target location. Among the types of signals that are popularly used for WP (e.g., Bluetooth, Zigbee, and Wi-Fi), ultra-wideband (UWB) is known to achieve high positioning accuracy, as it communicates on a large bandwidth that provides high distance resolution. In addition, UWB is known to have a high signal-to-noise ratio (SNR) and penetration ability, from which more reliable and robust WP can be performed.

Existing WP algorithms can be categorized into two classes: geometric methods and fingerprinting methods. Geometric methods require each sensor to take a set of informative measurements from the exchanged signals and transfer them to the DFC. Potential measurements include received signal strength (RSS), time of arrival (TOA), time difference of arrival (TDOA), and angle of arrival (AOA). Using these measurements, the DFC predicts the target location via a standard estimation algorithm (e.g., weighted least squares or gradient descent). Fingerprinting methods, in contrast, utilize a pre-acquired set of labeled measurements (i.e., the location information is available for each measurement obtained) to feed data-driven approaches for estimating the target location. The labeled data can be used to compare with incoming measurements directly (e.g., through nearest-neighbor methods) or as training data for learning a parametric classification model like a support vector machine (SVM).

While geometric methods typically involve considerably lower complexity than fingerprinting methods, the latter approaches usually lead to more accurate and more robust performance. For example, WP using TOA measurements (a geometric method) shows low accuracy when the channel experiences non-line-of-sight (NLOS) conditions, calling for compensation techniques to recover the performance. On the other hand, in order to improve accuracy and achieve robustness against varying channel conditions, fingerprinting often uses a large-dimensional input feature space—commonly, the power delay profile (PDP)—which can lead to high complexity to carry out the training process.

With the rapid development of machine learning (ML) techniques, research on learning-based WP has recently progressed. Deep learning frameworks have proven to be effective solutions to various fingerprinting-based WP approaches. In particular, neural networks have been shown to successfully handle key tasks of WP, like location estimation, ranging error mitigation, and channel condition classification. Moreover, various types of neural networks have been applied to solve WP problems in complex channel environments. For example, WP algorithms using convolutional neural networks (CNN), long short-term memory (LSTM), and gated recurrent units (GRU) have shown improved performance across different channel conditions and positioning environments. Additionally, more recent works on learning-based WP have adopted new learning mechanisms (e.g., model-agnostic meta-learning and knowledge transfer) to improve the performance further.

Although these works have shown promising results and significantly contributed to deep learning-based WP, processing high-dimensional features as is often required can become a limiting factor for many mobile applications. For one, in PDP-based approaches, this data must be measured and collected for each positioning instance, which naturally imposes a large bandwidth and/or a long latency on the sensor network. Also, neural networks with high-dimensional features may require high computational power (i.e., costly hardware) to support fast positioning rates. These operational constraints can be undesirable, especially for devices or machines in which both latency and cost are critical factors. While there exist some works that utilize low-dimensional feature data (e.g., TOA/RSS-based WP via neural networks and a linear estimator), their performance is still heavily impacted by channel conditions, which may require additional tasks like ranging error detection.

To address this issue, metaheuristic-based feature selection methods have been recently proposed in wireless positioning. In some of these works, the feature set is refined by an access point selection step, conducted via, e.g., binary particle swarm optimization or genetic algorithm. Moreover, the work adopted whale optimization algorithm to determine a set of effective features for intrusion detection. While these metaheuristic approaches show effective performance in feature selection, the algorithms in general require careful fine-tuning of their feature size and search space.

What is needed is a wireless positioning system that can deliver high-accuracy location estimates while operating under stringent computational and bandwidth constraints typical of mobile platforms.

### SUMMARY

A method for determining a position of a target device using a wireless positioning system is described herein. The method comprises receiving, with a processor, a plurality of data sets from a plurality of sensors of the wireless position system that measured a radio impulse signal transmitted by the target device. The plurality of data sets includes a respective data set from each respective sensor in the plurality of sensors. Each respective data set includes a subset of elements from a respective power-delay profile vector. The respective power-delay profile vector has been determined based on the radio impulse signal measured at the respective sensor. The method further comprises determining, with the processor, a position of the target device by processing the plurality of data sets using a neural network.

### BRIEF DESCRIPTION OF THE DRAWINGS

The foregoing aspects and other features of the systems and methods are explained in the following description, taken in connection with the accompanying drawings.

FIG. 1 shows visual illustrations of a geographical layout of positioning spaces and the channel propagation.

FIG. 2 shows an overall procedure for wireless positioning using UWB sensors.

FIG. 3 shows a visual illustration of our channel model.

FIG. 4 shows an overall architecture of the positioning neural network (P-NN).

FIG. 5 shows a comparison between an original PDP image and our sparse PDP image.

FIG. 6 shows the structure of the self-attention layer.

FIG. 7 shows a visual illustration of our key measurement parameters for the case of F=20.

FIG. 8 shows a plot of numerical values of PDP,

$${P}_{t h}^{( F )} and {ψ}_{F}^{2}$$

computed for the feature size selection example when F∈[3,8].

FIG. 9 shows a plot of numerical values computed for the feature size selection example: L̅L̅_̅{̅F̅}̅−̅L̅L̅₀̅ (left) and a plot of acquisition probability

$$\{ {\{ {P}_{F}^{( F )} \}}_{f = 1}^{F} ( right )$$

### for F∈[3,8].

FIG. 10 shows plots of numerical values computed for the feature size selection example.

FIG. 11 shows an exemplary embodiment of a wireless positioning system.

FIG. 12 shows a logical flow diagram for a method for determining a position of a target device using a wireless positioning system.

FIG. 13 shows an illustration of training and testing sets in a 2D plane.

FIG. 14 shows classification performance vs. feature size plot of different feature size reduction methods.

FIG. 15 shows performance vs. SNR of different WP algorithms with residential LOS channels.

FIG. 16 shows performance vs. SNR of different WP algorithms with residential NLOS channels.

FIG. 17 shows performance vs. SNR of different WP algorithms with outdoor LOS channels.

FIG. 18 shows performance vs. SNR of different WP algorithms with outdoor NLOS channels.

FIG. 19 shows classification rates obtained with 10, 15, and 20 dB SNRs by different WP algorithms (left) and the number of dimensions (right).

FIG. 20 shows RMSE performance vs. SNR of different WP algorithms with residential channels.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

A wireless positioning system and methods for wireless positioning are disclosed herein. The system and methods advantageously leverage a positioning neural network (P-NN) that utilizes the minimum description features to substantially reduce the complexity of deep learning-based WP. The system and method's minimum description feature selection strategy is based on maximum power measurements and their temporal locations to convey information needed to conduct WP. The P-NN's learning ability is advantageously improved by intelligently processing two different types of inputs: a sparse image and measurement matrices. The P-NN takes these inputs and processes them using a set of convolutional, self-attention, and fully-connected layers.

Utilizing the minimum description feature set enables the system and methods to provide an improved performance-complexity tradeoff. Particularly, instead of using the full PDP vectors. The P-NN utilizes only the largest power measurements and their temporal locations to generate a low-dimensional feature set. Also disclosed is a technique to adaptively select the size of the feature set to keep the performance robust across diverse channel conditions, thereby optimizing over the expected information gain and the classification capability quantified with information-theoretic measures on signal bin selection. The system and methods adopt the principle of model order selection and leverage the criterion formulated with the log-likelihood, acquisition probability, and Kullback-Leibler (KL) divergence.

The system and methods disclosed herein advantageously eliminate the careful fine-tuning of feature size and search space required by existing metaheuristic-based feature selection methods. Also, the system and methods incorporate more wireless-specific modeling (e.g., leveraging the channel properties) to exploit the wireless positioning setup.

Numerical results show that the P-NN can provide classification accuracies and robustness matching more computationally expensive baselines and thus achieve better performance-complexity tradeoff. Particularly, the numerical results show that the P-NN achieves a significant advantage in performance-complexity tradeoff over deep learning baselines that leverage the full power delay profile (PDP). In particular, we find that P-NN achieves a large improvement in performance for low SNR, as unnecessary measurements are discarded in our minimum description length features.

### System Model

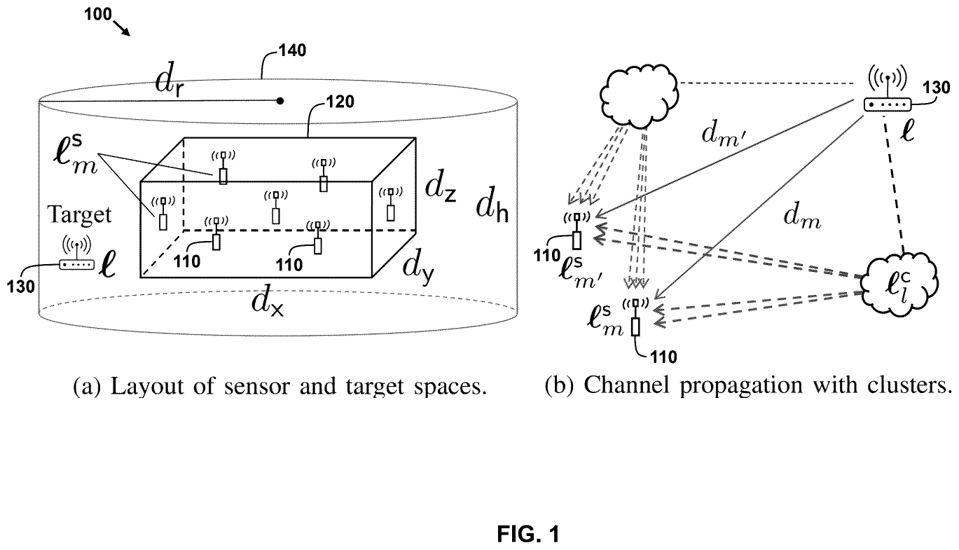

FIG. 1 shows visual illustrations of a geographical layout of positioning spaces (a) and the channel propagation (b). In illustration (a), we consider the geographical layout 100 of our WP scenario. M single-antenna UWB sensors 110 are placed in a rectangular sensor space 120 defined by the length parameters dₓ, d_{y}, and d_{z}. We use

$${ℓ}_{m}^{s} = {[ {x}_{m}^{s} , {y}_{m}^{s} , {z}_{m}^{s} ]}^{T}$$

to denote the location of sensor m∈{0,1, . . . , M−1}. We aim to localize a target device 130 positioned outside the sensor space 120 but inside a cylindrical target space 140 defined by the radius dᵣ and height dₕ. We assume that both the sensor and target spaces are centered at (0,0,0) where

$${d}_{h} > {d}_{z} and {d}_{r}^{2} > {( \frac{{d}_{x}}{2} )}^{2} + {( \frac{{d}_{y}}{2} )}^{2}$$

so that the entire sensor space 120 is placed inside the target space 140. Note that we specifically assume the positioning layout in FIG. 1 to consider WP conducted in a mobile environment (e.g., WP performed by vehicles, drones, etc.), where the sensors are relatively clustered in the center and the target device 130 of interest is, in general, located outward.

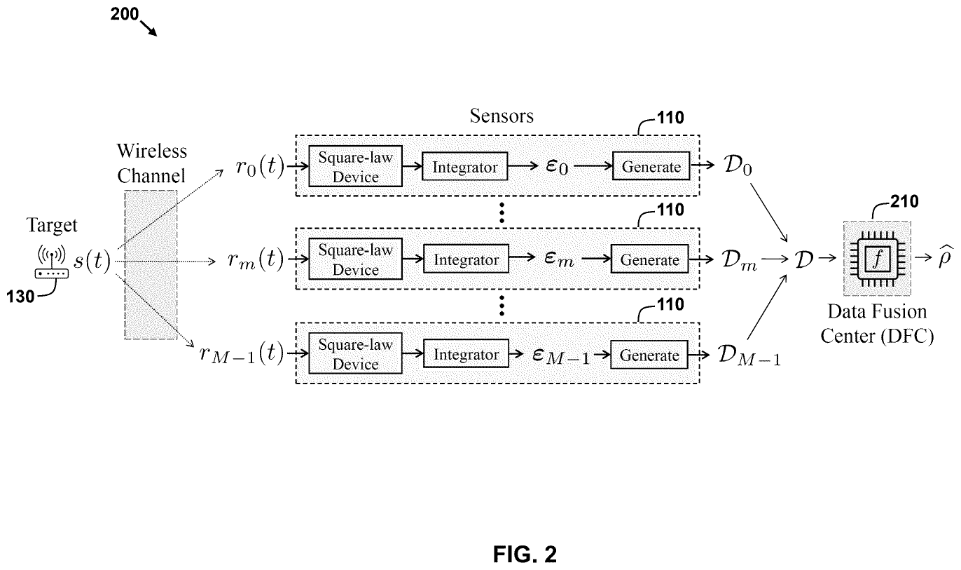

FIG. 2 shows an overall procedure 200 for wireless positioning using UWB sensors 110. Suppose that a target device 130 located at [symbol] =[x, y, z]^{T} transmits a radio impulse signal of duration Tₛ that is known to both the target device 130 and the sensors 110. Each sensor 110 uses an energy detector for the power measurement. After going through a bandpass filter of bandwidth W to remove the out-of-band noise, the baseband signal received by sensor 110 (m) can be expressed as

$${r}_{m} ( t ) = {\sum }_{l = 0}^{L} {\sum }_{k = 0}^{{K}_{l} - 1} {a}_{m , 1 , k} {e}^{j {ϕ}_{m , l , k}} \times s ( t - \frac{{d}_{m}}{c} - {T}_{m , 1} - {τ}_{m , l , k} ) + {w}_{m} ( t ) , \qquad ( 1 )$$

where L+1 is the number of propagation paths, and Kₗ is the number of rays existing in each path l. Here, we use l=0 to refer to the line-of-sight (LOS) path and l=1, 2, . . . , L to index the L non-line-of-sight (NLOS) paths. In equation (1), we use s(t) to denote the lowpass equivalent representation of the transmitted impulse. We use a_{m,l,k}e^{jφ}^{_{m,l,k}} to denote the complex channel gain, where a_{m,l,k} and φ_{m,l,k} are the weight and the uniformly distributed phase, respectively. We assume that the channel weight a_{m,l,k} follows a Nakagami distribution of Nakagami factor μ_{m,l,k} and mean-square value Ω_{m,l,k}. In some embodiments, we assume that the Nakagami factor μ_{m,l,k} follows a log-normal distribution of mean μ̅ and variance \tilde{μ}, i.e., ln(μ_{m,l,k})˜ [symbol] (μ̅,\tilde{μ}). The term wₘ(t) represents zero-mean complex Gaussian noise of variance

$${σ}_{n , m}^{2} ,$$

i.e., wₘ(t)˜ [symbol] (0, σ_{n,m}²). Each sensor 110 forwards a data set [symbol] to a data fusion center 210.

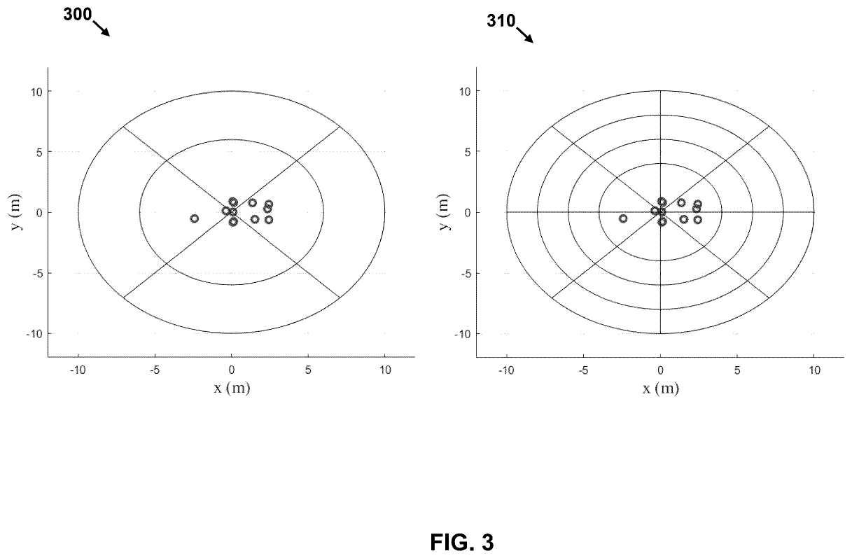

FIG. 3 shows a visual illustration of our channel model. On the left, a plot 300 shows zone layouts with N_{z}=8. On the right, a plot 310 shows zone layouts with N_{z}=32. The zones are created using radius and angle for practical outward positioning settings. The small circles indicate sensor positions.

In the following, we describe the delay parameters of equation (1). Let us define

$${d}_{m} = {‖ {ℓ}_{m}^{s} - ℓ ‖}_{2}$$

distance between the target device 130 and the sensor m. Then, with c being the speed of light constant, dₘ/c represents the TOA of the LOS path. We use T_{m,l} to denote the relative delay of the path l with respect to the LOS path, which is expressed as

$${T}_{m , l} = \{ \begin{matrix}0 & if l = 0 , \\ \frac{{‖ {ℓ}_{l}^{c} - ℓ ‖}_{2} + {‖ {ℓ}_{m}^{s} - {ℓ}_{l}^{c} ‖}_{2} - {d}_{m}}{c} & if l > 0 ,\end{matrix} \qquad ( 2 )$$

where

$${ℓ}_{l}^{c} = {[ {x}_{l}^{c} , {y}_{l}^{c} , {z}_{l}^{c} ]}^{T}$$

is the location of a cluster that imposes a path l∈{1, . . . , L}. The term τ_{m,l,k} denotes the relative delay of the ray k with respect to T_{m,l}, where k is indexed in ascending order, i.e., τ_{m,l,k} increases with k for given m and l. Hence, τ_{m,l,0}=0 for all sensors and paths. For k>0, we assume each ray follows the distribution of the density function p(τ_{m,l,k}|τ_{m,l,k-1})=κe^{-κ(τ}^{_{m,l,k}}^{-τ}^{_{m,l,k-1)}}, where κ is the ray arrival rate. Based on the parameters defined above, the TOA of each existing channel ray is expressed as

$$\frac{{d}_{m}}{c} + {T}_{m , l} + {τ}_{m , l , k} .$$

We now provide the details of the channel fading model. First, we define β_{m,0,0} to be the path loss of the LOS path channel between the target device 130 and sensor 110 (m), the expression of which is given as

$${β}_{m , 0 , 0} = 𝔼 [ {a}_{m , 0 , 0}^{2} ] = {S}_{m}^{s} {{\overline{P}}_{m} ( {d}_{m} / {\overline{d}}_{m} )}^{- ξ} , \qquad ( 3 )$$

where P̅ₘ, d̅ₘ, ξ are the reference power, reference distance, and pathloss exponent, respectively.

$${S}_{m}^{s}$$

represents the random shadowing that follows a zero-mean log-normal distribution with variance

$${σ}_{s}^{2} ,$$

i.e., ln

$$( {S}_{m}^{s} ) ∼ 𝒩 ( 0 , {σ}_{s}^{2} ) .$$

The pathloss of the non-line-of-sight (NLOS) path channels, denoted by β_{m,l,k} for l>0 and k>0, is expressed as

$${β}_{m , l , k} = 𝔼 [ {a}_{m , l , k}^{2} ] = {S}_{l}^{c} {β}_{m , 0 , 0} {e}^{- \frac{{T}_{m , l}}{Γ}} {e}^{- \frac{{τ}_{m , l , k}}{γ}} , \qquad ( 4 )$$

where Γ and γ are the cluster and ray decaying constants, respectively. The term

$${S}_{l}^{c}$$

denotes the cluster shadowing what follows a zero-mean log-normal distribution with variance

$${σ}_{c}^{2} ,$$

i.e., ln

$$( {S}_{l}^{c} ) ∼ 𝒩 ( 0 , {σ}_{c}^{2} ) .$$

With equations (3) and (4), each path loss becomes strongly dependent on the channel propagation distance, which allows the channel paths to convey spatial correlation. To make the channel fading reflect the path loss, we set Ω_{m,l,k}=β_{m,l,k}, ∀m, l, k.

We assume that the signal s(t) is transmitted within a frame of duration T_{f} such that

$${T}_{f} > {max}_{m , l , k} ( \frac{{d}_{m}}{c} + {T}_{m , l} + {τ}_{m , l , k} )$$

(i.e., the frame has a guard period). This ensures that each sensor 110 safely captures rₘ(t) and avoids inter-signal interference. With reference again to FIG. 2, in each sensor 110, the received frame is processed by an energy detector that consists of a square-law device and an integrator. Instead of applying a matched filter, which requires at least the Nyquist sampling rate and, thus, imposes a significant increase in the implementation complexity, our method adopts a low-complexity energy detector that can operate on sub-Nyquist rates to consider mobile applications with low-cost sensors. For integration, the frame is broken down to

$${N}_{b} = ⌊ \frac{{T}_{f}}{{T}_{g}} ⌋$$

temporal bins, where T_{g} is the integration period, and the power contained in each temporal bin n∈{0,1, . . . , N_{b}−1} of sensor 110 (m) is measured as

$${ε}_{m , n} = \frac{1}{2} {\int }_{n {T}_{g}}^{( n + 1 ) {T}_{g}} {\vert {r}_{m} ( t ) \vert}^{2} dt . \qquad ( 5 )$$

Now, we define the instant PDP vector measured at sensor 110 (m) as εₘ=[ε_{m,0}, ε_{m,1}, . . . , ε_{m,N}_{_{b}}₋₁]^{T}. For a signal of bandwidth W, equation (5) can be written as

$${ε}_{m , n} = \frac{1}{2 W} {\sum }_{i = 0}^{2 {WT}_{g} - 1} {\vert {r}_{m} ( {nT}_{g} + \frac{i}{2 W} ) \vert}^{2} . \qquad ( 6 )$$

Each sensor 110 (m) generates a data set [symbol] from εₘ and transfers it to the DFC. Using the collected set

$$𝒟 = {\{ {𝒟}_{m} \}}_{m = 0}^{M - 1} ,$$

the DFC estimates the location of the target device 130. In this disclosure, we frame our WP as an N_{z}-zone classification task. Example layouts for N_{z}=8 and N_{z}=32 are provided in FIG. 3, where the zones are created using radii and angles for practical mobile application settings. We pursue the zone classification task for the following reasons. First, rather than coordinate-level localization, positioning via N_{z} spatial zones is often sufficient in many vehicular operations, as the value of N_{z} can be adjusted to satisfy the positioning sensitivity and resolution. Second, it is more difficult to obtain coordinate-labeled training data than zone-labeled data. Hence, we define our positioning task using a function ƒ: [symbol] →\hat{ρ}, where \hat{ρ}∈{0,1, . . . , N_{z}−1} is the output indicating one of the N_{z} zones. Letting ρ∈{0, 1, . . . , N_{z}−1} denote the zone in which the target device 130 is truly located, the target device 130 is correctly positioned if \hat{ρ}=ρ.

### Positioning Neural Network (P-NN)

In this section, we provide implementation details of the P-NN, which executes the estimation function ƒ of the DFC in FIG. 2. In this section, we present our proposed set of minimum description features and provide the motivation. Then, we describe the architecture of P-NN. Finally, we explain the training and testing steps of the P-NN.

As mentioned previously, the P-NN is advantageously designed to leverage features of minimum description length. Particularly, many deep learning-based WP algorithms directly use full PDP data

$$( i . e . , 𝒟 = {\{ {ε}_{m} \}}_{m = 0}^{M - 1} )$$

to achieve high positioning accuracy and robust performance. Processing such high-dimensional features, however, often increases the operation requirement (e.g., bandwidth, memory, and power) since the data must be measured, collected, and processed by every positioning instance. This can be prohibitive, especially for mobile applications where the operational resources are fundamentally limited. Here, we follow the principle of minimum description length (MDL), which provides that the best model for describing data is one with the smallest size, and propose to use only a small number of the largest power measurements and their temporal locations.

Suppose that each sensor 110 (m) receives the signal rₘ (t) and measures the PDP vector εₘ of size N_{b}. The elements of εₘ are then sorted in descending order to yield

$${ε}_{m}^{o r d} = {[ {ε}_{m , 0}^{o r d} , {ε}_{m , 1}^{o r d} , … , {ε}_{m , {N}_{b} - 1}^{o r d} ]}^{T} ,$$

which satisfies

$${ε}_{m , 0}^{o r d} \geq {ε}_{m , 1}^{o r d} \geq … \geq {ε}_{m , {N}_{b} - 1}^{o r d} .$$

The sensor 110 (m) also acquires the index vector

$${b}_{m}^{o r d} = {[ {b}_{m , 0}^{o r d} , {b}_{m , 1}^{o r d} , … , {b}_{m , {N}_{b} - 1}^{o r d} ]}^{T} ,$$

where

$${b}_{m , n}^{o r d}$$

is the index of εₘ pointing to the entry value

$${ε}_{m , n}^{ord}$$

(i.e.,

$${b}_{m , n}^{ord}$$

indicates the temporal location in εₘ where the n-th largest power has been measured). The sensor 110 (m) then takes the first F entries of both

$${ε}_{m}^{ord} and {b}_{m}^{ord}$$

to generate

$${𝒟}_{m} = \{ {ε}_{m , 0}^{ord} , ... , {ε}_{m , F - 1}^{ord} , {b}_{m , 0}^{ord} , ... , {b}_{m , F - 1}^{ord} \}$$

of size 2F and transfers it to the DFC. As a result, the feature set [symbol] of size 2FM is collected at the DFC.

The key motivation for our feature set is an assumption that information needed for accurate WP is more likely present in the temporal bins of the largest powers. Effective TOA estimation algorithms are based on this assumption and use the power threshold to detect signals of significant power. In geometric WP algorithms, both RSS and TOA measurements become useful information for conducting WP. Therefore, we use both

$${ε}_{m}^{ord} and {b}_{m}^{ord} ,$$

which respectively represent RSS and TOA, to generate our feature set.

Using the full PDP is informative because the entire N_{b}M measurements are perceived as an image for neural networks to train and learn. By representing the PDP in the form of an image, the information needed to perform WP (e.g., the power and delay of signals received over multiple channel propagation paths) is converted to the spatial correlation across the image. However, if only a small fraction of N_{b} measurements actually convey useful information, it is more beneficial to process those measurements only. Nevertheless, taking the largest powers from N_{b} measurements (i.e., the first F entries of

$${ε}_{m}^{ord} )$$

can essentially lose information within the time domain. Hence, we directly include the temporal information (i.e., the first F entries of

$${b}_{m}^{ord} )$$

in our feature set.

Compared to having a PDP of size N_{b}, using our feature set reduces the dimension by a factor of

$$\frac{2 F}{{N}_{b}}$$

(e.g., F=5 and N_{b}=100 yields a size reduction by

$$\frac{1}{10} ) .$$

Since deep learning algorithms (e.g., CNNs with per-layer complexities that quadratically increase with feature dimensions) typically involve large data to be stored, transferred, and/or processed, a reduction in feature dimensions can result in benefits such as low storage, small bandwidth, and low computational complexity.

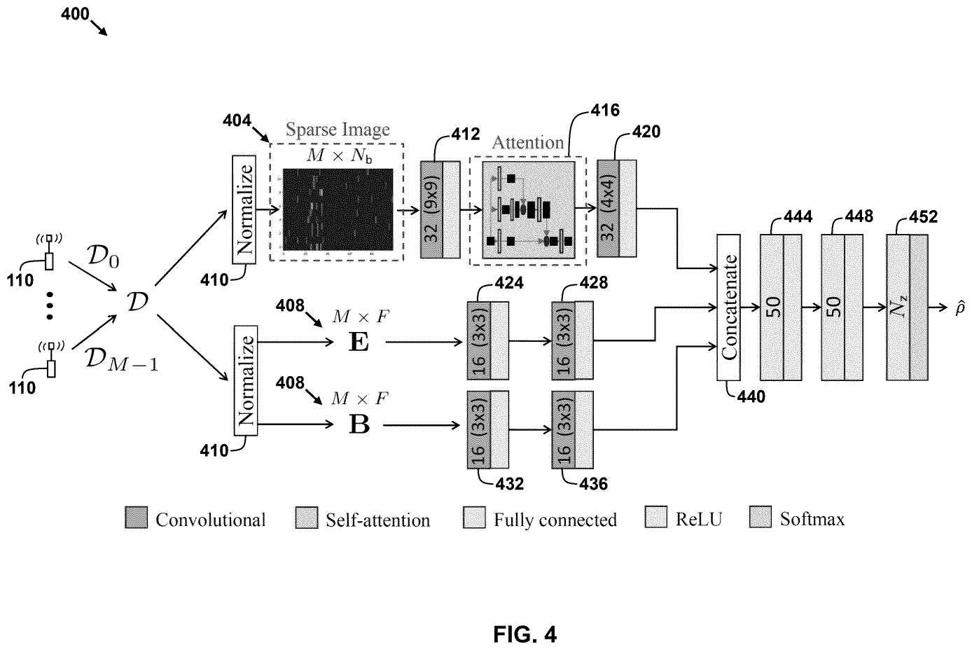

FIG. 4 shows an overall architecture of the positioning neural network (P-NN) 400. In summary, the P-NN 400 takes the feature set [symbol] as an input and transforms [symbol] into (i) a sparse image 404 and (ii) a pair of measurement matrices 408, each of which goes through a different set of neural network layers. Next, the separately processed data sources are concatenated for combined processing to ultimately output \hat{ρ} as the classification result. Note that such an architecture is based on the multi-channel approach, where input features are processed by several different paths to increase the information extraction capability. In what follows, we describe the three major components of this architecture.

The input to the upper branch of the P-NN 400 is a M×N_{b} sparse image 404 generated from the FM largest power measurements and their temporal locations. It should be appreciated that the sparse image can also be understood as a sparse matrix. Prior to generating the image, the power and temporal measurements are first normalized 410 by subtracting and then dividing the data by mean and standard deviation values, respectively. Here, we compute both the mean and standard deviation values from the training set. As discussed above, PDP data is often processed as an image since the location information is spatially conveyed across both the temporal bin n and sensor 110 (m). Hence, transforming the feature into an image format and feeding it through convolutional layers, which are particularly suited for spatial processing, is expected to be an effective approach. Our method takes a similar approach, but we only create a sparse image 404 by placing FM power measurements at their corresponding locations.

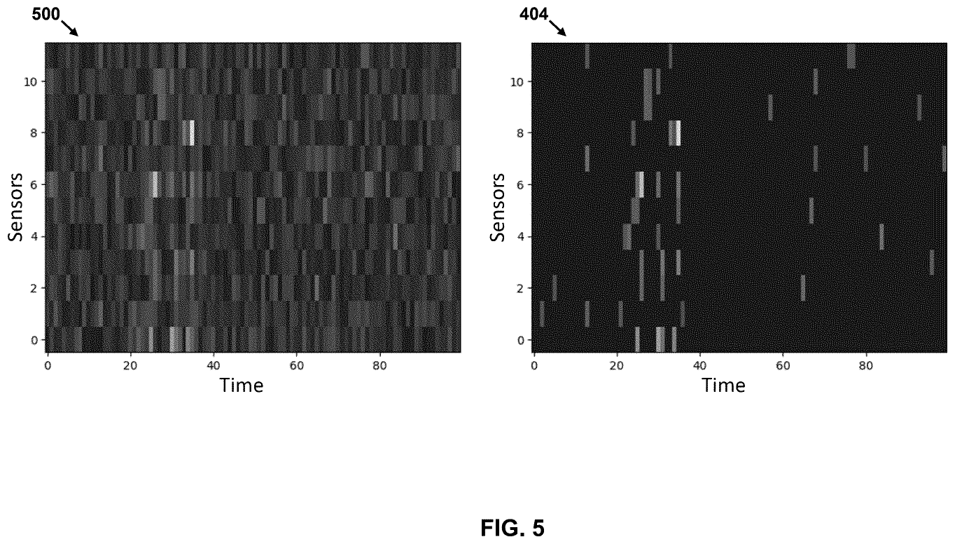

FIG. 5 shows a comparison between an original PDP image 500 and our sparse PDP image 404. The original PDP image 500, on the left, includes NOM measurements, whereas our sparse PDP image 404, on the right, includes 2FM measurements, where N_{b}=100, F=4, and M=12. As can be seen, we see that each row of the sparse PDP image 404 has only F non-zero points, where the magnitude is indicated by the distinctiveness of color/shading.

By processing the sparse image 404, we can attain the following two advantages. First, aligned with our main objective, the number of measurements needed to be collected for conducting WP is substantially reduced as compared to using the entire PDP. Note that we still use our feature set [symbol] of size 2FM to create an image. Second, as we generate our sparse image 404 only using a set of large powers, the measurements from noise-only temporal bins are likely to be discarded. This allows our neural network to concentrate only on the expressive portion of the image and avoid being trained by the noise measurements.

With reference again to FIG. 4, to process the sparse image 404 input, the P-NN 400 includes at least one convolutional layer 412 with rectified linear unit (ReLU) activation, followed by a self-attention layer 416, followed by at least one further convolutional layer 420 with ReLU activation. The convolutional layers 412 and 420 capture any significant correlation in the spatial domain. Note that the key role of convolutional layers is to spatially process a given image. Hence, to reinforce the capability of our spatial processing, the self-attention layer 416 is also incorporated. The self-attention layer 416 is designed to detect correlations present across certain parts of the input data. Different from the convolutional layers 412, 420, which focus on correlating a given image to its label, the self-attention layer 416 focuses on learning the correlation among different local regions within the image. The effectiveness of using an attention layer has been proven in computer vision and phrase recognition. Particularly, we implement the self-attention layer 416 to create synergy with our convolutional layers 412, 420.

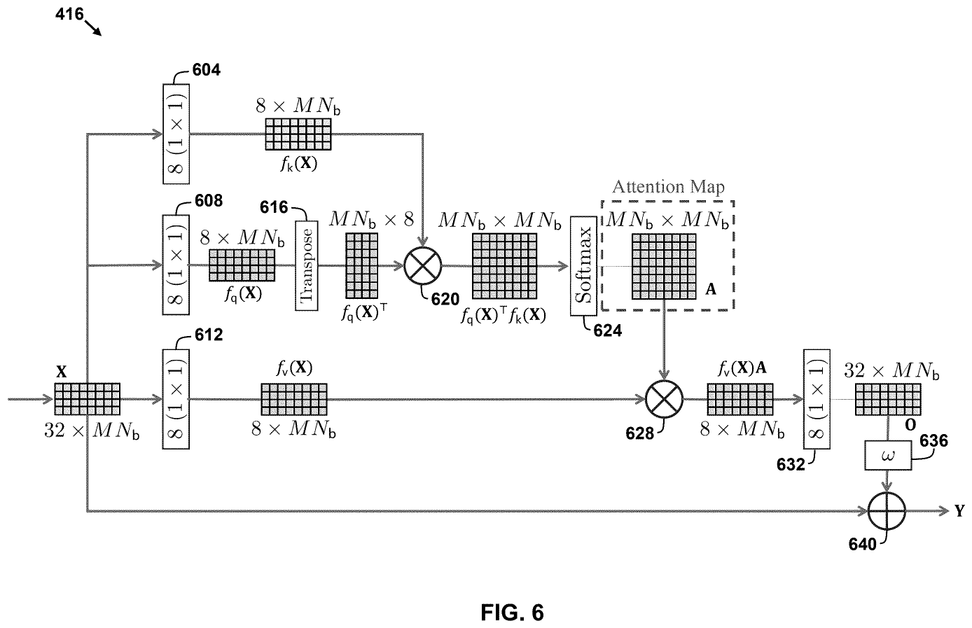

FIG. 6 shows the structure of the self-attention layer 416. We first reshape the input to 32×MN_{b} and process it with three individual 1×1 convolutional layers 604, 608, and 612 of eight channels to generate the components: query, key, and value, respectively. Each step here can be expressed as f_{q}(X)=W_{q}X, fₖ(X)=WₖX, and fᵥ(X)=WᵥX, where X is the 32×MN_{b} reshaped input and W_{q}, Wₖ, and Wᵥ are the 8×32 weight matrices for the convolutional layers 604, 608, and 612 corresponding to the query, the key, and the value, respectively.

The query is transposed by a transpose layer 616, and the query and key are combined via matrix multiplication 620 and activated with the softmax function 624 to yield the MN_{b}×MN_{b} attention map A, which can be expressed as A=fₛₘ(f_{q}(X)^{T}fₖ(X)), where fₛₘ(⋅) is the column-wise softmax operation. Note that this attention map A is the key aspect of the self-attention layer 416, as each matrix element represents the degree of attention we need to put when processing two specific regions of the image input together. In other words, the value of [A]_{i,j} indicates how much attention the model needs to give to the region i when it processes the region j of the image.

Next, the attention map A obtained from the query and key is multiplied by our value fᵥ(X) via matrix multiplication 628 to yield an output of size 8×MN_{b}. The output then goes through a 1×1 convolutional layer 632 of 32 channels to generate a 32×MN_{b} matrix O, which can be expressed as O=W_{z}fᵥ(X)A, where W_{z} is the 32×8 weight matrix for the convolutional layer 632. As the last step, the matrix O is combined with the original input X using a trainable scalar weight ω via a scaling layer 636 and a summation 640, i.e.,

$$Y = ω O + X , \qquad ( 7 )$$

where Y becomes the final output of the self-attention layer 416. The weight ω is initialized as zero to make our neural network focus on local regions first (i.e., the self-attention layer 416 has no impact on the overall learning via ω=0). Through training, the self-attention layer 416 gradually captures the attention and feeds it to the network via equation (7).

By inserting the self-attention layer 416 for our sparse image 404 processing, we aim to reinforce the learning ability of the P-NN 400. Note that the operation of the self-attention layer 416 can be simply described using linear operations of multiple weights W_{q}, Wₖ, Wᵥ, W_{z}, and ω. As compared to adding a recurrent layer to the neural network for extracting attention, the self-attention layer 416 does not impose a sequential operation and provides training models that are easier to interpret.

With reference again to FIG. 4, the inputs to the lower branches of the P-NN 400 are power and time measurement matrices 408. Particularly, to provide another input format, we separate the power and time measurements from [symbol] , normalize them using the mean and standard deviation values obtained from the training data, and generate two M×F matrices

$$E = [ \begin{matrix}{ε}_{0 , 0}^{ord} & … & {ε}_{0 , F - 1}^{ord} \\ ⋮ & ⋱ & ⋮ \\ {ε}_{M - 1 , 0}^{ord} & … & {ε}_{M - 1 , F - 1}^{ord}\end{matrix} ] and B = [ \begin{matrix}{b}_{0 , 0}^{ord} & … & {b}_{0 , F - 1}^{ord} \\ ⋮ & ⋱ & ⋮ \\ {b}_{M - 1 , 0}^{ord} & … & {b}_{M - 1 , F - 1}^{ord}\end{matrix} ] .$$

As shown in FIG. 4, we feed each measurement matrix E and B into separate neural network layers of the P-NN 400 to handle the data obtained from two different domains. Particularly, the measurement matrix E is processed by convolutional layers 424, 428 with ReLU activation to capture spatial correlation across both the measurements and sensors. Similarly, the measurement matrix B is processed by convolutional layers 432, 436 with ReLU activation to capture temporal correlation across both the measurements and sensors.

Recall that, in our sparse image 404 generation, the temporal information is exploited through the F largest power measurements being placed in specific locations. Then, we rely on the learning ability of convolutional layers to successfully capture the spatial correlation. Different from our sparse image 404 processing, we directly feed the measurement matrices 408 so that our network has access to the numerical values of signal powers and delays. By doing so, we provide the network with a different way to process the features and extract information. For example, the time measurements collected in B can be interpreted as a set of TOA values, which is a popularly used metric in WP.

With continued reference to FIG. 4, the P-NN 400 includes a concatenation layer 440 that flattens and concatenates the outputs of our two separate networks (i.e., the results of processing the sparse image 404 and measurement matrices 408). The concatenated output from the concatenation layer 440 is fed to a set of two fully connected (FC) layers 444 and 448 with ReLU activation. The final layer 452 is designed with N_{z} neurons and softmax activation to output a classification vector that is directly translated to a zone-based position \hat{ρ}. In an alternative embodiment, the final layer 452 is replaced by a regression layer that has three neurons with linear activation for estimating a 3D coordinate position \hat{ρ}. The latter set of FC layers is to combine the information separately extracted from the sparse image 404, E, and B and determine the position of the target device 130.

Since we design our WP in the supervised learning framework, an offline training phase is required for collecting the labeled dataset. To train the P-NN 400, we first acquire a training set of size D, where each data point is indexed by i∈{0,1, . . . , D−1} consists of the feature set

$${𝒟}^{( i )} = {\{ {𝒟}_{m}^{( i )} \}}_{m = 0}^{M - 1}$$

and the zone index ρᵢ for its label. To impose unbiased learning, we obtain approximately the same number of data points from each zone (i.e., around

$$\frac{D}{{N}_{z}}$$

data points from each zone ρ∈{0,1, . . . , N_{z}−1}). The network is trained offline via Adam optimizer. During the online testing phase, the feature set [symbol] is obtained from the sensors 110 in real-time and forward-fed through the neural network to determine the positioning outcome \hat{ρ}.

### Adaptive Feature Size Selection

As discussed previously, the F largest powers and their temporal locations are collected from each of the M sensors 110 to form our feature set of size 2FM. Here we develop an effective strategy to adaptively determine the value of F as the number of measurements to be taken by each sensor 110 for accurate WP varies by channel conditions. To select the value of F, we adopt the principle of model order selection and develop a unique feature size selection method. Model order selection enables the system to effectively determine the dimension or size of a model by evaluating the criterion formulated to numerically represent the objective.

In this section, we first define three parameters that are used to evaluate the effectiveness of our feature set when the F largest power measurements are considered. Next, we present our feature size selection criterion and provide an example demonstrating the selection steps.

### Parameter Definitions:

Information coming from F signal bins: Note that taking the F largest power measurements for our feature set can be seen as assuming that F out of the N_{b} bins contain the signal. Since each sensor 110 measures the power according to equation (6), these F signal-containing bins are assumed to follow a non-central chi-square distribution, which we approximate using a central chi-square distribution of probability density function (PDF) given as

$$f ( x ; {ψ}^{2} , λ , v ) = {( \frac{1}{2 {η}^{2}} )}^{\frac{v}{2}} \frac{{x}^{\frac{v}{2} - 1}}{Γ ( \frac{v}{2} )} exp ( - \frac{x}{2 {η}^{2}} ) , \qquad ( 8 )$$

where

$${η}^{2} = \sqrt{\frac{2 v {ψ}^{4} + 4 {ψ}^{2} λ + {( v {ψ}^{2} + λ )}^{2}}{v ( 2 + v )}}$$

with ψ², λ, and ν being the non-central chi-square parameters and Γ(⋅) is the Gamma function. The other N_{b}−F bins are assumed to only contain noise, and we approximate them using the central chi-square distribution (i.e., we set λ=0 in equation (8)).

For every data collected during the training, each sensor 110 (m) is supposed to find

$${ε}_{m}^{o r d} .$$

Hence, using these measurements as samples (i.e., a set of

$${\{ {ε}_{m}^{o r d} \}}_{m = 0}^{M - 1}$$

that are measured to generate D data points), we can compute

$${\overline{ε}}^{o r d} = {[ {\overline{ε}}_{0}^{o r d} , {\overline{ε}}_{1}^{o r d} , … , {\overline{ε}}_{{N}_{b} - 1}^{o r d} ]}^{T} ,$$

where

$${\overline{ε}}_{n}^{o r d}$$

is the power of the n-th largest temporal bin averaged over both the sensors 110 and data points. We express the joint PDF of F non-central and N_{b}−F central chi-square variables using equation (8) (with appropriate values of λ) as

$$f ( x ; {ψ}_{0}^{2} , … , {ψ}_{{N}_{b} - 1}^{2} , {λ}_{0} , … , {λ}_{F - 1} , v ) = {\prod }_{n = 0}^{F - 1} {( \frac{1}{2 {η}_{n}^{2}} )}^{\frac{v}{2}} \frac{{x}_{n}^{\frac{v}{2} - 1}}{Γ ( \frac{v}{2} )} exp ( - \frac{{x}_{n}}{2 {η}_{n}^{2}} ) \times {\sum }_{n = F}^{{N}_{b} - 1} {( \frac{1}{2 {ψ}_{n}^{2}} )}^{\frac{v}{2}} \frac{{x}_{n}^{\frac{v}{2} - 1}}{Γ ( \frac{v}{2} )} exp ( - \frac{{x}_{n}}{2 {ψ}_{n}^{2}} ) , \qquad ( 9 )$$

where

$${η}_{n}^{2} = \sqrt{\frac{2 v {ψ}_{n}^{4} + 4 {ψ}_{n}^{2} {λ}_{n} + {( v {ψ}_{n}^{2} + {λ}_{n} )}^{2}}{v ( 2 + v )}} and x = {[ {x}_{0} , … , {x}_{{N}_{b} - 1} ]}^{T} .$$

From equation (9), we derive the likelihood of having

$${\overline{ε}}^{o r d}$$

$$ln f ( \overline{{ε}^{o r d}} ; {ψ}_{0}^{2} , … , {ψ}_{{N}_{b} - 1}^{2} , {λ}_{0} , … , {λ}_{F - 1} , v ) = {{\sum }^{F - 1}}_{n = 0} = - \frac{v}{2} ln ( 2 {η}_{n}^{2} ) + \frac{v - 2}{2} ln ( {\overline{ε}}_{n}^{o r d} ) - ln Γ ( \frac{v}{2} ) - \frac{{\overline{ε}}_{n}^{o r d}}{2 {η}_{n}^{2}} + {\sum }_{n = F}^{{N}_{b} - 1} - \frac{v}{2} ln ( 2 {ψ}_{n}^{2} ) + \frac{v - 2}{2} ln ( {\overline{ε}}_{n}^{o r d} ) - ln Γ ( \frac{v}{2} ) - \frac{{\overline{ε}}_{n}^{o r d}}{2 {ψ}_{n}^{2}} . \qquad ( 10 )$$

Note that equation (10) is characterized by N_{b} values of

$${ψ}_{n}^{2} ,$$

F values of λₙ, and a single value of ν=2WT_{g}. Since we do not have the knowledge of

$${\{ {ψ}_{n}^{2} \}}_{n = 0}^{{N}_{b} - 1} and {\{ {λ}_{n} \}}_{n = 0}^{F - 1}$$

to evaluate equation (10), we estimate each term using

$${ψ}_{F}^{2} = \frac{1}{{N}_{b} - F} {\sum }_{n = F}^{{N}_{b} - 1} {\overline{ε}}_{n}^{o r d} \approx {ψ}_{n}^{2} , ∀ n = 0 , … , {N}_{b} - 1 , \qquad ( 11 )$$

$${λ}_{n}^{( F )} = {\overline{ε}}_{n}^{o r d} - {ψ}_{F}^{2} \approx {λ}_{n} , ∀ n = 0 , … , F - 1 , \qquad ( 12 )$$

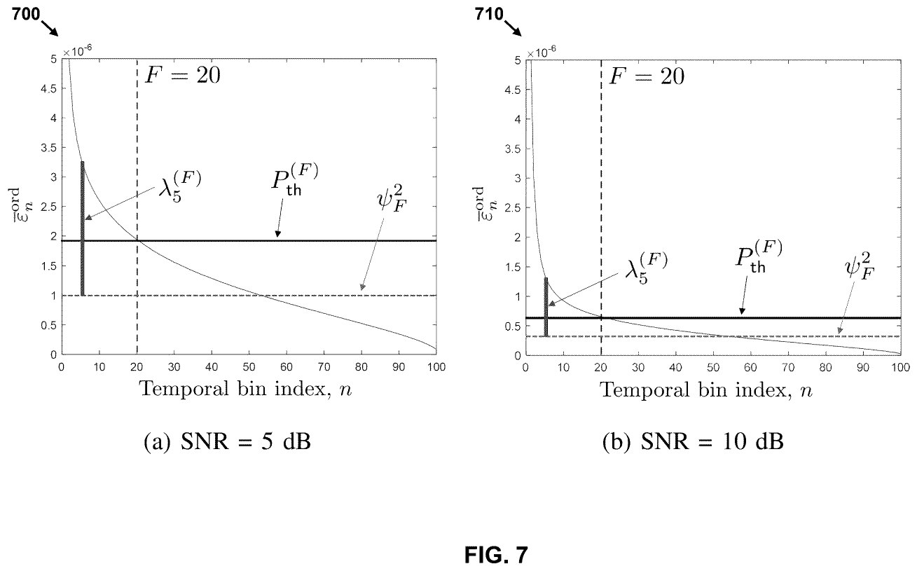

The terms (11) and (12) can be respectively seen as the noise and signal powers estimated using the observations. FIG. 7 shows a visual illustration of our key measurement parameters for the case of F=20. On the left, a plot 700 shows parameters for SNR=5 dB. In contrast, on the right, a plot 710 shows parameters for SNR=10 dB.

Using (11) and (12), we now define the estimated likelihood or having

$${\overline{ε}}^{o r d}$$

when the F largest powers are taken for our feature set (i.e., F bins are assumed to contain signals) as

$$L {L}_{F} = ln f ( {\overline{ε}}^{o r d} ; {ψ}_{F}^{2} , … , {ψ}_{F}^{2} , {λ}_{0}^{( F )} , … , {λ}_{F - 1}^{( F )} , v ) . \qquad ( 13 )$$

For a given

$${\overline{ε}}^{o r d} ,$$

the value of equation (13) varies by F, and we utilize this parameter to evaluate the expected amount of information when F measurements are taken for our feature set. Note that the log-likelihood is an effective metric popularly used for the information-theoretic model order selection.

In what follows, we rationalize the usage of equation (13) in our feature size criterion formulation by analyzing its behavior for the high SNR regime. From equation (1), we have

$${\sum }_{l = 0}^{L} {K}_{l}$$

independent signal paths that fall across No temporal bins, and let us define 1≤\tilde{F}≤N_{b} to be the number of temporal bins that actually contain these signals. Note that \tilde{F} is deterministic but unknown. Since we desire to take the most useful information from the PDP but keep our feature dimensions as low as possible, \tilde{F} intuitively becomes the ideal number of measurements for our feature size selection.

As we vary the value of F to adaptively determine the feature dimension, two possible cases take place regarding the relationship between F and \tilde{F}: (i) F≤\tilde{F} with which we select a smaller number of measurements than desired, but have a higher chance of successfully discarding noise-only measurements and (ii) F>\tilde{F} where we successfully take the entire measurements from signal-containing bins, but allow our features to include extra measurements that are potentially useless.

Recall that we utilize the sorted power measurement vector

$${\overline{ε}}^{o r d}$$

to generate our feature set. Out of the N_{b} entries of

$${\overline{ε}}^{o r d} ,$$

\tilde{F} of them contain both the signal and noise, and the rest N_{b}−\tilde{F} bins only convey the noise. Since the power of each temporal bin is strictly dependent on the power of its components, with high SNR, powers from the \tilde{F} signal-containing bins are measured much greater than the rest, and most likely placed in the first \tilde{F} entries of

$${\overline{ε}}^{o r d}$$

after sorting. Hence, we apply the following assumption to our analysis.

Assumption 1. In high SNR scenarios, the first \tilde{F} entries of

$${\overline{ε}}^{o r d}$$

are significantly greater than the rest, and those N_{b}−F entries are negligibly small and approximately the same, i.e.,

$${\overline{ε}}_{0}^{o r d} \geq … \geq {\overline{ε}}_{\tilde{F} - 1}^{ord} ≫ {\overline{ε}}_{F}^{ord} \approx … \approx {\overline{ε}}_{{N}_{b} - 1}^{o r d} . \qquad ( 14 )$$

Now, we remove expressions that are not affected by F from equation (13) for conciseness and obtain

$$= {\sum }_{n = 0}^{F - 1} - \frac{v}{2} ln ( 2 {η}_{F , n}^{2} ) - \frac{{\overline{ε}}_{n}^{o r d}}{2 {η}_{F , n}^{2}} + {\sum }_{n = F}^{{N}_{b} - 1} - \frac{v}{2} ln ( 2 {ψ}_{F}^{2} ) - \frac{{\overline{ε}}_{n}^{o r d}}{2 {ψ}_{F}^{2}} , \qquad ( 15 )$$

where

$${η}_{F , n}^{2} = \sqrt{\frac{2 v {ψ}_{F}^{4} + 4 {ψ}_{F}^{2} {λ}_{n}^{( F )} + {( v {ψ}_{F}^{2} + {λ}_{n}^{( F )} )}^{2}}{v ( 2 + v )}} . \qquad ( 16 )$$

Note that, since we aim to analyze the behavior of equation (13) in terms of our control variable F, equation (15) becomes a sufficient expression to draw conclusions that are also applicable to equation (13). Depending on the value of F with respect to \tilde{F}, we introduce the following proposition regarding the behavior of equation (15).

Proposition 1. Based on the approximation made in Assumption 1, the value of [symbol] , which is given by equation (15), is a non-decreasing function of F when F≤\tilde{F} and does not change with F when F>\tilde{F}.

Using Proposition 1, which can also be applied to equation (13), we claim that our log-likelihood metric equation (13) reaches a non-unique maximum value as F approaches to \tilde{F} with high SNR. Therefore, even though we do not have the knowledge of \tilde{F}, maximizing equation (13) over a given range of F can lead us to the most effective decision on the size of our feature set.

Information acquisition probability: Another parameter we define is the probability of acquiring useful information when we consider the F largest power measurements. Due to the time-varying nature of the wireless channel, the power across the N_{b} temporal bins are randomly measured at each positioning instance. In other words, despite the effort to generate our feature set using only the signal-containing bins, it is possible for the set to include measurements from the noise-only bins. Such a case is not desirable since data with no useful information can degrade the performance of the P-NN 400.

Thus, for a given value of F, we quantify the chance of our feature set taking measurements from the signal-containing bins. Recall that taking the F largest power measurements is to assume F signal-containing bins out of N_{b}. First, we define

$${P}_{t h}^{( F )} = ( {\overline{ε}}_{F - 1}^{o r d} + {\overline{ε}}_{F}^{o r d} ) / 2$$

to be the power threshold that separates the first F bins from the rest N_{b}−F bins (See FIG. 7). Our logic is that the feature set will likely include these signal-containing bins if their power is measured greater than

$${P}_{t h}^{( F )} .$$

Hence, using equations (11) and (12), we define the probability of a signal-containing bin n∈{0, . . . , F−1} to have the power greater than

$${P}_{t h}^{( F )}$$

as

$$\begin{matrix}{p}_{n}^{( F )} = ℙ \{ \frac{{ε}_{n}^{o r d}}{{ψ}_{F}^{2}} > \frac{{P}_{t h}^{( F )}}{{ψ}_{F}^{2}} \vert \frac{{λ}_{n}^{( F )}}{{ψ}_{F}^{2}} \} \\ = {Q}_{\frac{v}{2}} ( \sqrt{2 {( {λ}_{n}^{( F )} / {ψ}_{F}^{2} )}^{2}} , \sqrt{2 {P}_{t h}^{( F )} / {ψ}_{F}^{2}} ) ,\end{matrix} \qquad ( 17 )$$

where ε^{ord} is the power measured in the n-th largest bin, which follows a chi-square distribution of parameters

$${λ}_{n}^{( F )} , {ψ}_{F}^{2} ,$$

and ν upon assuming F signal-containing bins, and

$${Q}_{\frac{v}{2}} ( . , . )$$

is the

$$\frac{v}{2} - th$$

order Marcum Q-function. Based on equation (17), we define the acquisition probability of our F largest powers to include the measurements from f∈{0, 1, . . . , F} signal-containing bins as

$${P}_{f}^{( F )} = {\sum }_{q ∈ {Q}_{f}^{( F )}} {\prod }_{i = 1}^{F} {( {p}_{i - 1}^{( F )} )}^{q [ i ]} {( 1 - {p}_{i - 1}^{( F )} )}^{( 1 - q [ i ] )} , \qquad ( 18 )$$

where

$${Q}_{f}^{( F )}$$

is the set of all F-length binary vectors containing f ones (i.e.,

$${Q}_{f}^{( F )}$$

considers all

$$\frac{F !}{f ! ( F - f ) !}$$

cases where f out of F bins have their power greater than

$${P}_{t h}^{( F )} ) .$$

The product term in equation (18) computes the joint probability of each case in

$${Q}_{f}^{( F )} ,$$

and the summation provides the overall probability. Note that equation (18) quantifies the chance of taking f useful measurements when we consider the F largest measurements for our feature set.

Inter-zone Kullback-Leibler divergence: Dissimilarity among the class distributions is one of the key factors that impact classification performance, and how we form our feature set directly affects this dissimilarity. Hence, for a given value of F, we propose to quantify the dissimilarity across the data samples from each zone via KL divergence and use it for our feature size selection. To evaluate KL divergence, the PDFs must be known. Since we only have empirical measurements (i.e., training data), we take the k-nearest neighbors (KNN) density estimation approach to directly estimate the KL divergence. If we subgroup the training data by each zone in terms of our feature set and denote each group using

$${𝒟}_{z}^{z}$$

for z∈{0, 1, . . . , N_{z}−1}, the estimated KL divergence between the zone z and z′ using the KNN density estimation with u nearest neighbors is given by

$${\hat{D}}_{u} ( {P}_{z} ‖ {P}_{{z}^{′}} ) = \frac{F}{\vert {𝒟}_{z}^{z} \vert} {\sum }_{x ∈ {D}_{z}^{z}} log \frac{{r}_{u , {z}^{′}} ( x )}{{r}_{u , z} ( x )} + log \frac{\vert {𝒟}_{{z}^{′}}^{z} \vert}{\vert {𝒟}_{z}^{z} \vert - 1} , \qquad ( 19 )$$

where r_{u,z}(x) is the Euclidean distance between x and its u-th nearest neighbor in

$${𝒟}_{z}^{z} .$$

Now we define an empirical KL divergence upon taking the F largest power measurements as

$$K {L}_{F} = \frac{1}{{N}_{z}^{2} \sqrt{F}} {\sum }_{i = 0}^{{N}_{z}} {\sum }_{j = 0}^{{N}_{z}} {\hat{D}}_{u} ( {P}_{i} ‖ {P}_{j} ) , \qquad ( 20 )$$

which we use to quantify how effectively our feature set of size 2FM can separate the classes. Note that, regardless of the distributions being compared, equation (19) yields a steady increase with F due to the volume expression used in the KNN density estimation. Hence, a factor of \sqrt{F} is applied in equation (20) to account for the increase in the expected Euclidean distance across F.

Selection Criterion Formulation: Using the parameter equations (13), (18), and (20), we now formulate our feature size selection criterion, which is expressed as

$${F}^{*} = {arg max}_{F ∈ [ {F}_{min} , {F}_{max} ]} ( ϵ {\underbrace{{\sum }_{f = 0}^{F} {sP}_{f}^{( F )} \frac{f}{F} \overline{{LL}_{F} - {LL}_{0}}}}_{( a )} + ( 1 - ϵ ) \overline{{\underbrace{{KL}_{F}}}_{( b )}} ) \qquad ( 21 )$$

where (̅⋅̅)̅ implies the normalization with respect to max_{F}(⋅) and ϵ∈[0,1] is the weight parameter. To determine F*, our feature size selection reflects two factors: the effective amount of information, i.e., (a), and classification capability, i.e., (b), attainable from taking the F largest powers and their temporal locations. Since the cost function is the weighted sum of (a) and (b), we force the range of both (a) and (b) to be [0,1] by normalizing

$${\{ L {L}_{F} - L {L}_{0} \}}_{F = {F}_{min}}^{{F}_{max}} and {\{ K {L}_{F} \}}_{F = {F}_{min}}^{{F}_{max}} .$$

In the following, we elaborate on our choice of these cost function terms in equation (21).

First, we use the term (a) in our cost function to reflect the effective amount of information. Recall that LL_{F} is the log-likelihood representing the overall amount of information contained in the F largest measurements. To quantify the relative increase in information, we subtract LL₀ from LL_{F} and normalize to compute L̅L̅_̅{̅F̅}̅−̅L̅L̅₀̅. Then, to account for the chance that only f of our F measurements are actually useful (i.e., the measurements are from f signal-containing bins and F−f noise-only bins), we weight our log-likelihood expression L̅L̅_̅{̅F̅}̅−̅L̅L̅₀̅ with a factor and the acquisition probability

$${P}_{f}^{( F )} .$$

We compute this value for each case of f∈{0,1, . . . , F} and sum them up to obtain the term (a). Note that, as the term reflects the likelihood of our features to include measurements from noise-only temporal bins, taking more measurements (i.e., a larger value of F) may not always lead to an increase in the effective amount of information.

Next, we use the term (b) in our cost function to reflect the classification capability. As explained above, the empirically estimated KL divergence in equation (20) serves as an effective metric to quantify the dissimilarity across class distributions. Hence, we directly adopt this parameter into our cost function to reflect the classification performance expected from utilizing the F largest measurements. Note that, unlike (a) in equation (21), the term (b) in our cost function relies on the statistical properties of the dataset and thus focuses on measuring the effectiveness of the dataset in differentiating the classes.

Example 1. We provide a numerical example of our feature size selection using the setting of 15 dB SNR and LOS condition. For brevity, we set N_{b}=10, [Fₘᵢₙ, Fₘₐₓ]=[3,8], ν=2, and ϵ=0.5. From the given setting, we assume to have obtained ε̅^{ord}=[53.9, 26.8, 17.4, 12.5, 9.46, 5.35, 4.72, 3.36, 2.96, 2.55]×10⁻⁷, where the first five entries contain the signal (i.e., \tilde{F}=5). Below, we provide some of the key numerical values computed for the given example.

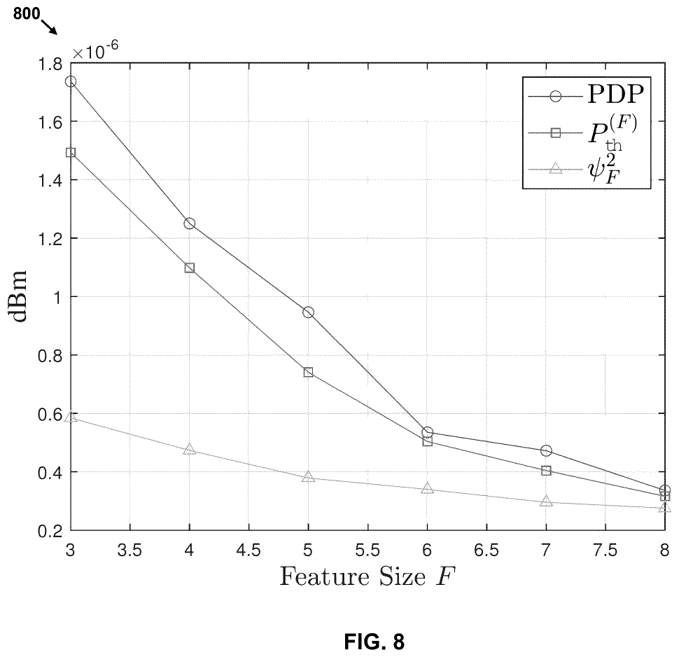

Particularly, FIG. 8 shows a plot 800 of numerical values of PDP,

$${P}_{t h}^{( F )} and {ψ}_{F}^{2}$$

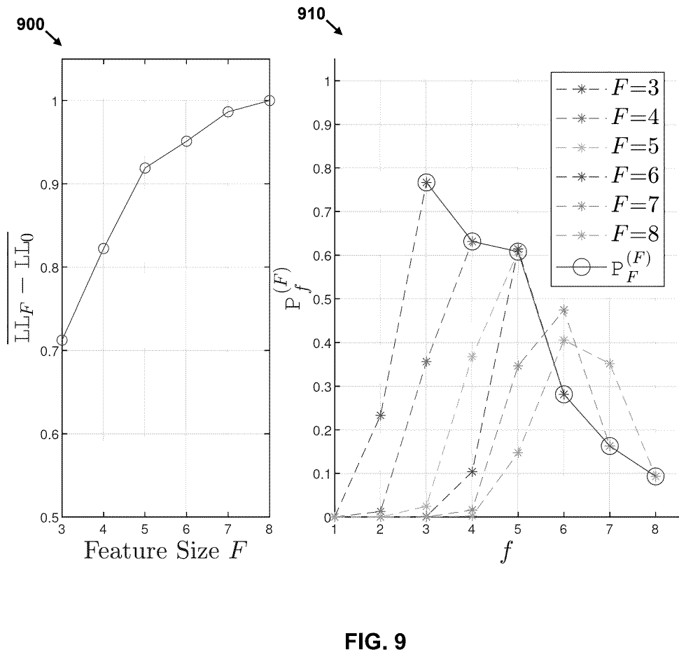

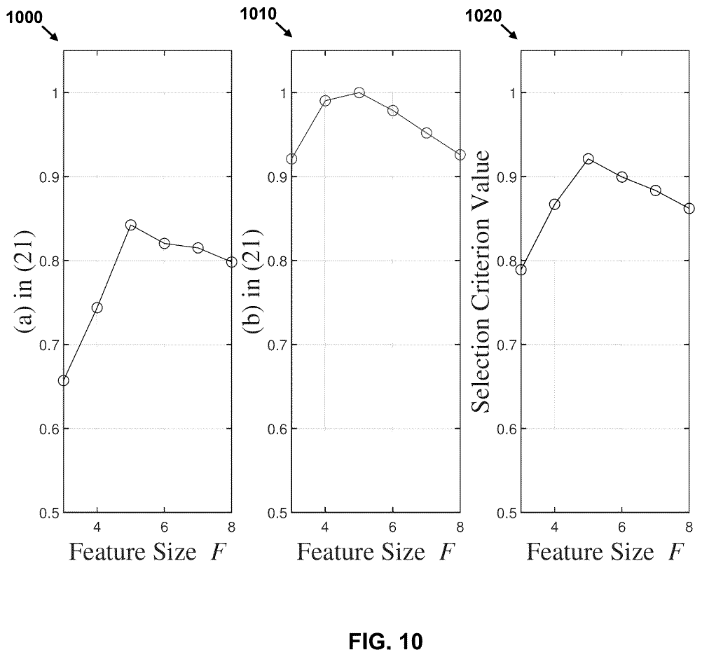

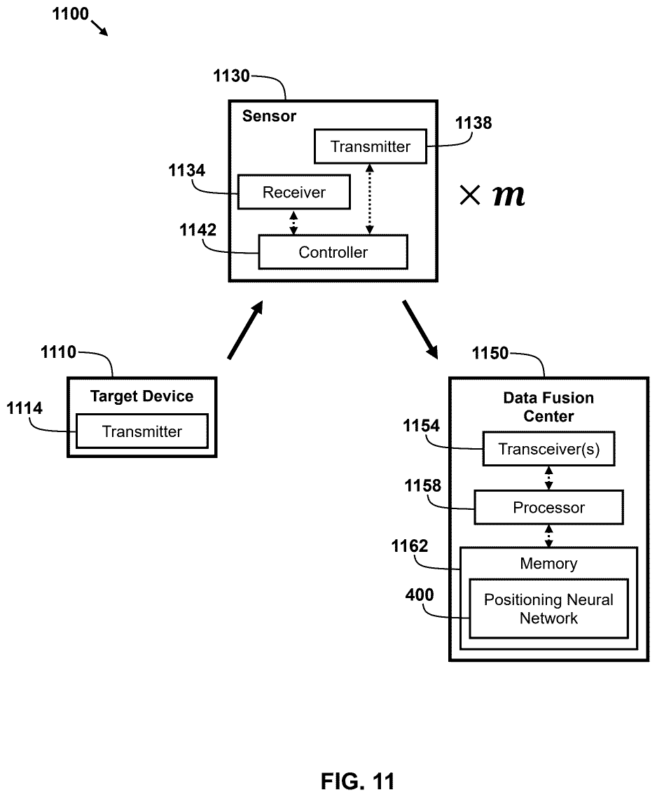

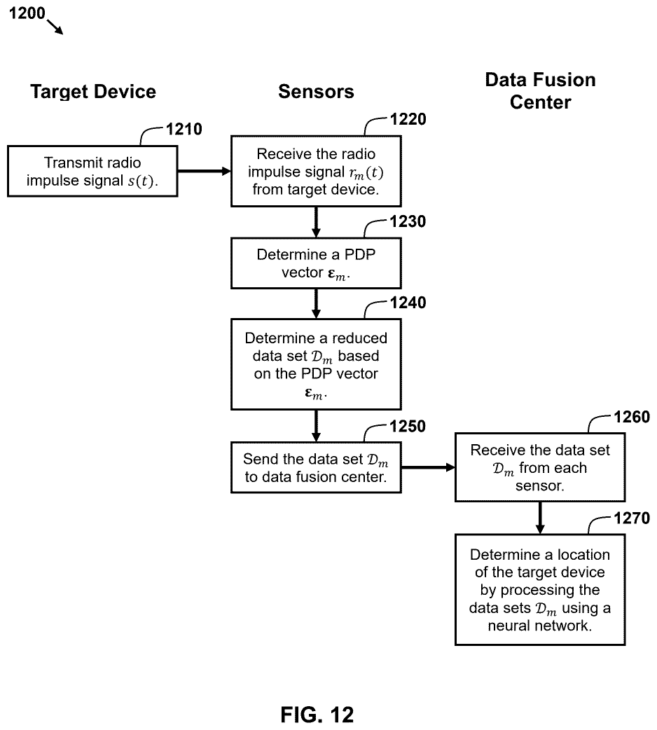

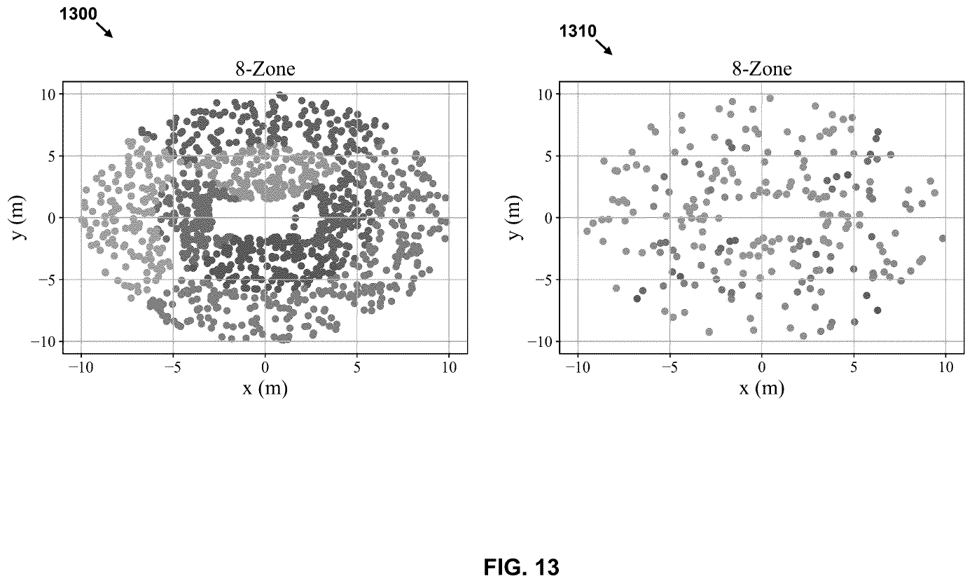

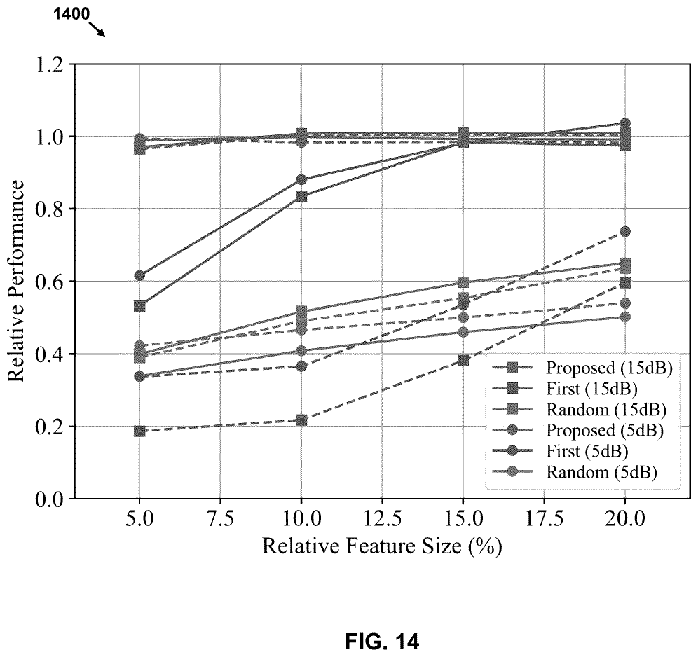

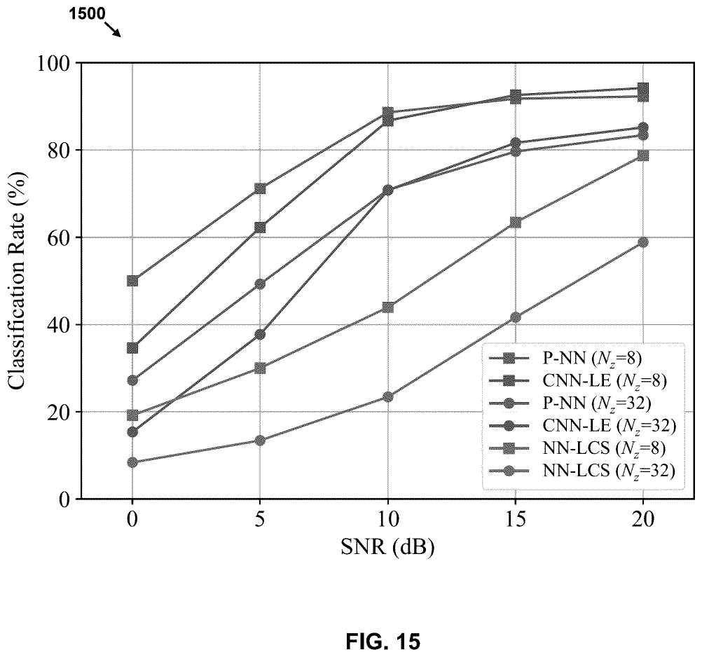

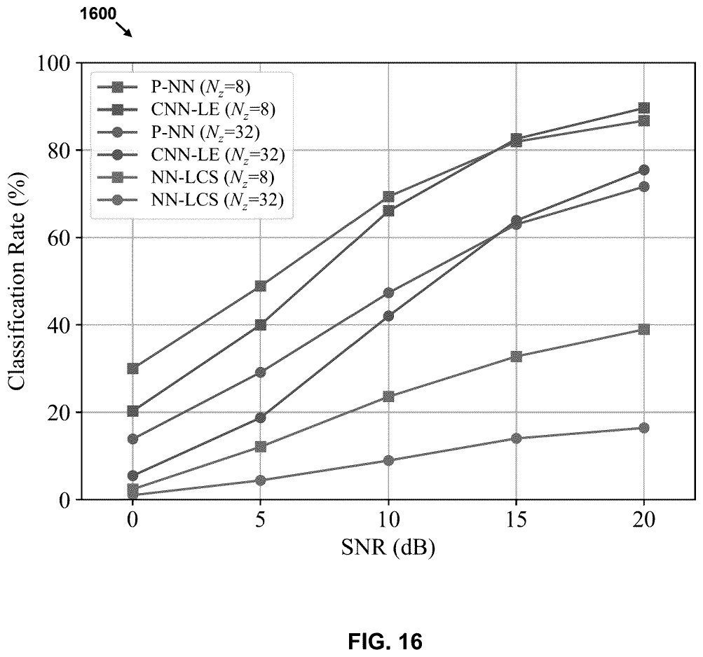

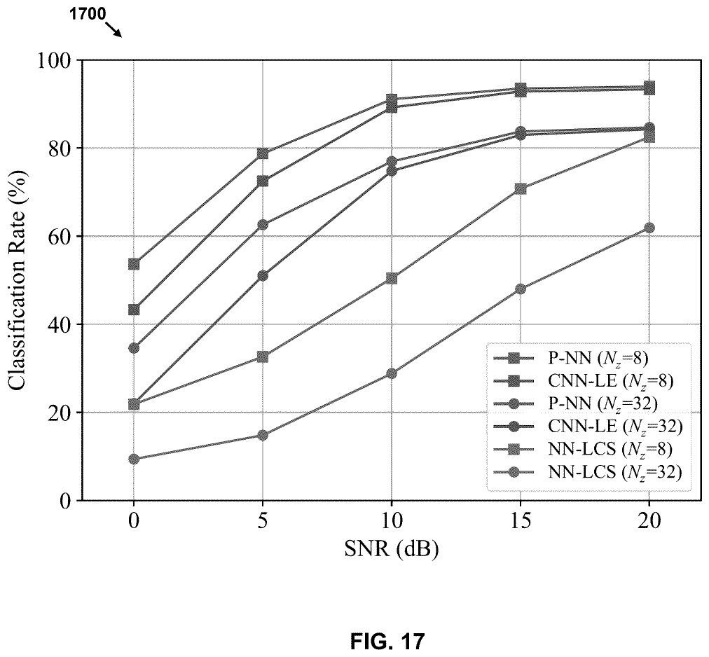

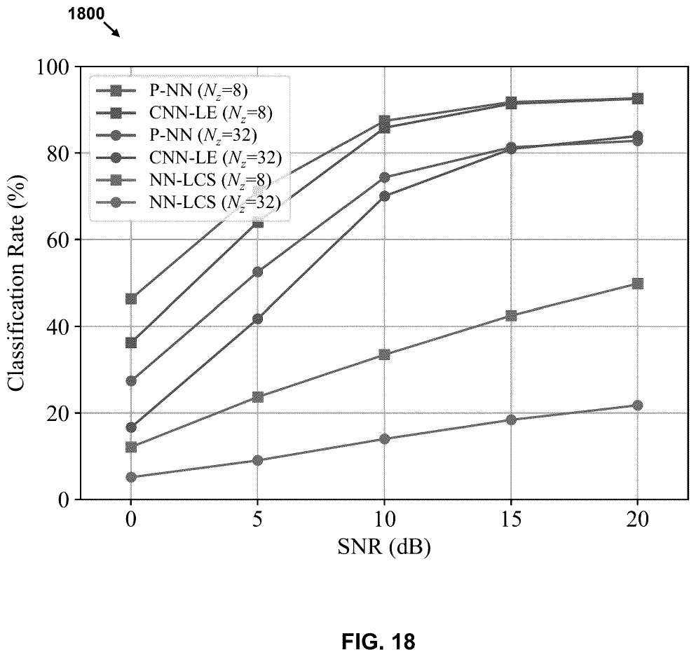

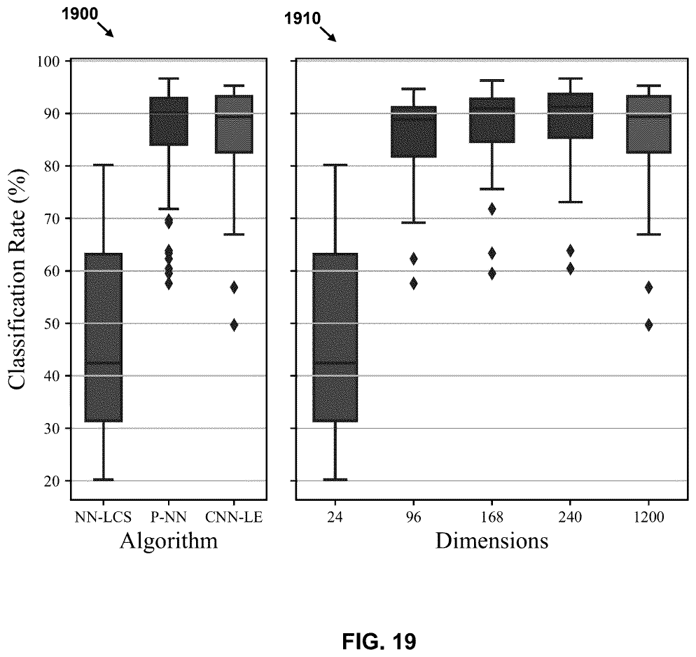

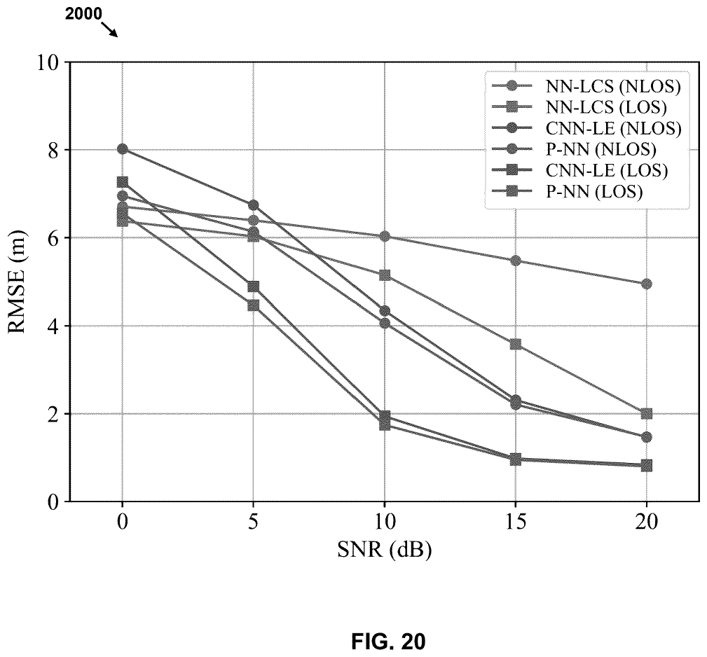

computed for the feature size selection example when F∈[3,8]. Next, FIG. 9 shows a plot 900 of numerical values computed for the feature size selection example: L̅L̅_̅{̅F̅}̅−̅L̅L̅₀̅ (left) and a plot 910 of acquisition probability

$$\{ {\{ {P}_{F}^{( F )} \}}_{f = 1}^{F}$$

(right) for F∈[3,8]. Finally, FIG. 10 shows plots 1000, 1010, 1020 of numerical values computed for the feature size selection example: in equation (21) (left), (b) in equation (21) (middle), and final selection criterion value (right), respectively.

We see that L̅L̅_̅{̅F̅}̅−̅L̅L̅₀̅ shows a non-decreasing behavior in F (the left plot of FIG. 9), which supports our Proposition 1. Note that the increase in L̅L̅_̅{̅F̅}̅−̅L̅L̅₀̅ is more pronounced for F≤\tilde{F} and relatively diminished for F>\tilde{F}. This implies that L̅L̅_̅{̅F̅}̅−̅L̅L̅₀̅ reflects the amount of useful information contained in each temporal bin.

Moreover, despite the non-decreasing behavior of L̅L̅_̅{̅F̅}̅−̅L̅L̅₀̅, (a) in equation (21), actually decreases for F>5 (the left plot of FIG. 10). Since a larger F reduces the gap between

$${P}_{t h}^{( F )} and {ψ}_{F}^{2}$$

(FIG. 8), it contributes to a decrease in the information acquisition probabilities (e.g.,

$${P}_{F}^{( F )}$$

decreases with F in the right plot of FIG. 9) and results in a reduction in the effective amount of information. Table I shows numerical values of the key parameters used in our feature size selection steps, where

$${ψ}_{F}^{2} , {λ}_{n}^{( F )} , and {P}_{t h}^{( F )}$$

are in the unit of 10⁻⁷.

TABLE I

| F | 3 | 4 | 5 | 6 | 7 | 8 |
|---|---|---|---|---|---|---|
| ${ψ}_{F}^{2}$ | 5.84 | 4.73 | 3.79 | 3.40 | 2.96 | 2.76 |
| $\{ {λ}_{Fn}^{F} \} \text{?}$ | {11. [symbol] } | {12.6, 7.8} | {13.6, 8.7, 5.7} | {14.0, 9.1, 6.1, 2.0} | {14.4, 9.5, 6.5, 2.4, 1.8} | {14.6, 9.7, 6.7, 2.6, 2.0, 0.6} |
| L̅L̅F̅ −̅ L̅L̅0̅ | 0.713 | 0.822 | 0.919 | 0.951 | 0.986 | 1 |
| $\text{?}$ | 14.93 | 10.98 | 7.41 | 5.04 | 4.04 | 3.16 |
| $( p \text{?} ) \text{?}$ | {0.77} | {0.96, 0.66} | {1.00. 0.93, 0.65} | {1.00, 0.99, 0.85, 0.33} | {1.00, 1.00, 0.95, 0.46, 0.37} | {1.00, 4.00, 0.98, |
| | | | | | | 0.58, 0.48, 0.34} |
| $\{ {P}_{f}^{( F )} \} \text{?}$ | {0.77} | {0.36, 0.63} | {0.02, 0.37, 0.61} | {0.00, 0.10, 0.61, 0.28} | {0.00, 0.02, 0.35, 0.47, 0.16} | {0.00, 0.00, 0.15, 0.41, 0.35, 0.09} |
| (a) in (21) | 0.687 | 3.744 | 0.842 | 0.820 | 0.815 | 0.798 |
| (b) in (21) | 0.921 | 0.990 | 1 | 0.979 | 0.952 | 0.926 |

[symbol]

indicates data missing or illegible when filed

Using the last two rows of Table I (or the left and middle plots of FIG. 10), we evaluate our cost function values for F∈[3,8] to be {0.79,0.87,0.92,0.90,0.88,0.86} (shown in the right plot of FIG. 10). As a result, our selection criterion in equation (21) determines F*=5 to be the number of measurements to be taken for our features, and this is equivalent to the actual number of signal-containing bins \tilde{F}=5.

The overall process of our feature size selection can be summarized as follows. First, for a given positioning scenario, the required information for evaluating the objective function of equation (21) is obtained. Then, from a given search range of F, the most effective feature size F* is determined using equation (21). Once F* is determined, we train the P-NN 400 using the features consisting of the F* largest powers and their temporal locations.

Note that our feature selection mechanism does not need any prior training of the P-NN 400. Hence, the model training complexity remains the same regardless of the search range of F in equation (21). Moreover, our feature size selection is conducted completely offline, which means that our algorithm can be practically adopted into learning-based WP systems without increasing their online operation complexity. Nevertheless, utilizing the P-NN 400 along with our feature size selection still requires a new set of training data and network training each time there is a considerable change in the localization environment.

### Exemplary Wireless Positioning System

FIG. 11 shows an exemplary embodiment of a wireless positioning system 1100. The wireless positioning system 1100 is broadly applicable to any scenario in which accurate, real-time knowledge of the spatial location of a target device 1110 is required. In one embodiment, the wireless positioning system 1100 is integrated into a vehicle. In this example, the wireless positioning system 1100 is used to determine the position of a driver's key fob, mobile phone, or other handheld device relative to the vehicle chassis for purposes such as keyless entry or similar functionality. In another embodiment, the wireless positioning system 1100 is deployed within a home. In this example, the wireless positioning system 1100 may be employed to determine the position of mobile devices of residents in order to enable context-aware smart-home services, such as automated lighting control. In another embodiment, the wireless positioning system 1100 is in a commercial or industrial building. In this example, e wireless positioning system 1100 may be employed to determine the position of autonomous robots, personnel, products, or equipment to support logistics, asset management, and navigation for robots. In any case, the wireless positioning system 1100 includes the target device 1110, a plurality of sensors 1130, and a data fusion center 1150.

The target device 1110 is any electronic system capable of emitting a radio impulse signal for the purpose of determining its spatial position relative to the plurality of sensors 1130 within the wireless positioning system 1100. To these ends, the target device 1110 at least includes a transmitter 1114 configured to transmit the radio impulse signal s(t). In some embodiments, the transmitter 1114 is, for example, an ultra-wideband (UWB), Bluetooth, Zigbee, or Wi-Fi transceiver. The transmitter 1114 may comprise one or more antennas, power supplies, signal processing circuitry, and firmware configured to transmit the radio impulse signal s(t). In practice, the target device 1110 may be embodied in a wide range of physical forms, including but not limited to: a handheld mobile phone or tablet; an unmanned aerial vehicle or autonomous ground robot (e.g., in an industrial setting); a vehicular positioning device installed in a car or truck (e.g., for fleet management); an industrial asset such as a storage pallet equipped with a wireless positioning tag; or any other portable device, such as a security badge or access card that requires location awareness.

The plurality of sensors 1130 are installed at suitably diverse locations within the environment of the wireless positioning system 1100. It should be appreciated that the arrangement and installation of the plurality of sensors 1130 depends on the application. For example, in vehicle applications, the sensors 1130 may be arranged and installed at various locations throughout the vehicle. Likewise, in residential, commercial, or industrial applications, the sensors 1130 may be arranged and installed at various locations throughout a building.

Each sensor 1130 is a device that captures a radio impulse signal s(t) transmitted by the target device 1110 and extracts the power-delay profile (PDP) data required for position estimation. To these ends, each sensor 1130 at least includes a receiver 1134, a transmitter 1138, and a controller 1142. In some embodiments, the receiver 1134 is, for example, an ultra-wideband (UWB), Bluetooth, Zigbee, or Wi-Fi transceiver. The receiver 1134 may comprise one or more antennas, power supplies, signal processing circuitry, and firmware configured to measure the received radio impulse signal rₘ(t). The transmitter 1138 is configured to provide a wired or wireless back-haul link to the data fusion center 1150. In at least some embodiments, the transmitter 1138 comprises an Ethernet/serial interface or similar wired interface that provides a wired back-haul link to the data fusion center 1150, but can also take the form of a wireless radio (e.g., Wi-Fi, BLE, UWB, or proprietary mesh).

The controller 1142 of each sensor 1130 is, for example, an embedded processor, with associated memory, that is configured to operate the receiver 1134 to measure the received radio impulse signal rₘ(t), to derive the PDP vector εₘ and the data set [symbol] , and to operate the transmitter 1138 to provide the data set [symbol] to the data fusion center 1150. It will be recognized by those of ordinary skill in the art that a “processor” includes any hardware system, hardware mechanism, or hardware component that processes data, signals, or other information. The processor may include a system with a central processing unit, graphics processing units, multiple processing units, dedicated circuitry for achieving functionality, programmable logic, or other processing systems.

The data fusion center 1150 serves as the central intelligence of the wireless positioning system 1100, aggregating and processing the data sets [symbol] received from all of the sensors 1130 to infer the spatial coordinates of the target device 1110. The data fusion center 1150 includes one or more transceivers 1154, a processor 1158, and a memory 1162. The memory 1162 at least stores program instructions corresponding to the positioning neural network (P-NN) 400. The transceivers 1154 are configured to, among other things, establish a back-haul link with each sensor 1130. The transceivers 1154 include, for example, an Ethernet/serial interface or similar wired interface that provides a wired back-haul link with the plurality of sensors 1130, but can also take the form of a wireless radio (e.g., Wi-Fi, BLE, UWB, or proprietary mesh). The processor 1158, for example, a CPU, GPU, or specialized AI accelerator, is configured to execute the positioning neural network 400 to process the data sets [symbol] to determine a classification output indicating the target's zone or a regression output indicating the target's precise location. The memory 1162 may be of any type of device capable of storing information accessible by the processor 1158, such as a memory card, ROM, RAM, hard drives, discs, flash memory, or any of various other computer-readable media serving as data storage devices, as will be recognized by those of ordinary skill in the art.

### Methods for Wireless Positioning Using Minimum Description Length PDP Data

A variety of methods for wireless positioning of a target device are discussed below. In the description of the method, statements that the method is performing some task or function refers to a controller or general-purpose processor (e.g., the controller 1142 or the processor 1158) executing programmed instructions stored in non-transitory computer readable storage media (e.g., a memory of the controller 1142 or the memory 1162) operatively connected to the controller or processor to manipulate data or to operate one or more components in the wireless positioning system 1100 to perform the task or function. Additionally, the steps of the methods may be performed in any feasible chronological order, regardless of the order shown in the figures or the order in which the steps are described.

FIG. 12 shows a logical flow diagram for a method 1200 for determining a position of a target device using a wireless positioning system. The method 1200 advantageously uses the minimum description length feature sets and the neural network architecture discussed above.

The method 1200 begins with the target device 1110 transmitting a radio impulse signal s(t) (block 1210). Particularly, a processor or controller of the target device 1110 operates the transmitter 1114 to broadcast the radio impulse signal s(t). The radio impulse signal s(t) has a duration Tₛ that is known to both the target device 1110 and the sensors 1130, and has a form that facilitates robust extraction of power-delay profile (PDP) characteristics from the received impulse by the plurality of sensors 1130.

The method 1200 continues with each of the plurality of sensors 1130 receiving the radio impulse signal rₘ(t) from the target device 1110 (block 1220). Particularly, the controller 1142 of each respective sensor 1130 operates the receiver 1134 to measure a respective radio impulse signal rₘ(t) received from the target device 1110. Each respective sensor 1130 uses an energy detector for the power measurement. After going through a bandpass filter of bandwidth W to remove the out-of-band noise, the radio impulse signal rₘ(t) received by sensor 110 (m) can be expressed according to equation (1), discussed above.

The method 1200 continues with each of the plurality of sensors 1130 determining a PDP vector εₘ (block 1230). Particularly, the controller 1142 of each respective sensor 1130 determines the respective power-delay profile (PDP) vector εₘ based on the radio impulse signal rₘ(t) measured at the respective sensor 1130. As discussed in greater detail above with respect to equations (2)-(6), the controller 1142 of each respective sensor 1130 processes the radio impulse signal rₘ(t) using an energy detector that consists of a square-law device and an integrator. The radio impulse signal rₘ(t) and the derived PDP vector εₘ is broken down to

$${N}_{b} = ⌊ \frac{{T}_{f}}{{T}_{g}} ⌋$$

temporal bins (also referred to herein as temporal indices).

The method 1200 continues with each of the plurality of sensors 1130 determining a reduced data set [symbol] based on the PDP vector εₘ (block 1240). Particularly, the controller 1142 of each respective sensor 1130 determines a respective data set [symbol] comprised of a subset of elements from the PDP vector εₘ. In at least some embodiments, the data set [symbol] further includes the temporal indices corresponding to the subset of elements from the respective PDP vector εₘ. In at least some embodiments, the data set [symbol] includes the predetermined number F largest elements and their corresponding temporal indices from the PDP vector εₘ. As discussed above, F is determined prior to deployment of the wireless positioning system 1100 and is determined depending on noise conditions and line-of-sight conditions of an environment in which the wireless positioning system 1100 is deployed.

In some embodiments, as discussed in greater detail above, the controller 1142 of each respective sensor 1130 determines the respective data set [symbol] by first reordering the respective PDP vector εₘ from the largest to the smallest elements to arrive at an ordered PDP vector

$${ε}_{m}^{o r d} .$$

Likewise, the controller 1142 also determines an ordered temporal index vector

$${b}_{m}^{o r d} .$$

Next, the controller 1142 identifies the F largest elements from the ordered PDP vector

$${ε}_{m}^{o r d}$$

and forms the respective data set [symbol] including the F largest elements from the PDP vector εₘ and the temporal indices corresponding thereto. In particular, the controller 1142 forms the respective data set [symbol] from the first F entries of both

$${ε}_{m}^{o r d} and {b}_{m}^{o r d}$$

to generate

$${𝒟}_{m} = \{ {ε}_{m , 0}^{o r d} , … , {ε}_{m , F - 1}^{ord} , {b}_{m , 0}^{o r d} , … , {b}_{m , F - 1}^{o r d} \}$$

of size 2F.

The method 1200 continues with each of the plurality of sensors 1130 sending the data set [symbol] to the data fusion center 1150 (block 1250). Particularly, the controller 1142 of each respective sensor 1130 operates the transmitter 1138 to send the respective data set [symbol] to the data fusion center 1150 via the wired or wireless back-haul link, as discussed above. It should be appreciated that the respective data set [symbol] is reduced in size compared to the respective PDP vector εₘ, thereby reducing the amount of bandwidth necessary to forward the data to the data fusion center 1150.

The method 1200 continues with the data fusion center 1150 receiving the data set [symbol] from each sensor (block 1260). Particularly, the processor 1158 of the target device 1110 operates the one or more transceivers 1154 to receive the respective data set [symbol] from each of the plurality of sensors 1130. In some embodiments, the respective data sets [symbol] are combined to form the complete data set [symbol] that is to be used to perform wireless positioning of the target device 1110.

The method 1200 continues with the data fusion center 1150 determining a location of the target device 1110 by processing the data sets [symbol] using a neural network (block 1270). Particularly, the processor 1158 determines a position of the target device 1110 by processing the plurality of data sets [symbol] using the P-NN 400. First, the processor 1158 normalizes the plurality of data sets [symbol] , as discussed above. Next, the processor 1158 forms a measurement matrix 408 (E) having dimensions M×F based on the plurality of data sets [symbol] , where M is the total number of sensors in the plurality of sensors and F is the predetermined number. The measurement matrix E includes the values

$${ε}_{m , 0}^{o r d} , … , {ε}_{m , F - 1}^{o r d}$$

form all of the plurality of data sets [symbol] . Similarly, the processor 1158 forms a measurement matrix 408 (B) having dimensions M×F based on the plurality of data sets [symbol] . The measurement matrix B includes the temporal indices

$${b}_{m , 0}^{o r d} , … , {b}_{m , F - 1}^{o r d}$$

from all of the plurality of data sets [symbol] .

Additionally, the processor 1158 forms the sparse image 404 having dimensions M×N_{b}, where N_{b} is the total number of temporal indices of the radio impulse signal rₘ(t) and/or of the PDP vector εₘ. In contrast to the measurement matrixes E and B, is sparsely populated with values. Particularly, the sparse image 404 including the values

$${ε}_{m , 0}^{o r d} , … , {ε}_{m , F - 1}^{o r d}$$

from all of the plurality of data sets [symbol] sparsely arranged according to the corresponding temporal indices 1 through N_{b}, each other value in the sparse image 404 being zero. Particularly, for each temporal index for which a value was not included in a respective data set [symbol] , the sparse image 404 includes a zero value.

The processor 1158 determines the position of the target device 1110 by processing the measurement matrix E, the measurement matrix B, and the sparse image 404 using the P-NN 400, which is described in greater detail above. Particularly, the processor 1158 executes the P-NN 400 with measurement matrix E, the measurement matrix B, and the sparse image 404 provided as inputs.

The P-NN 400 is configured to determine a first intermediate output by processing the measurement matrix E using a first subset of layers of the P-NN 400. The first subset of layers of the P-NN 400 includes the convolutional layers 424 and 428, which are configured to determine the first intermediate output from the measurement matrix E.

The P-NN 400 is configured to determine a second intermediate output by processing the measurement matrix B using a second subset of layers of the P-NN 400. The second subset of layers of the P-NN 400 includes the convolutional layers 432 and 436, which are configured to determine the second intermediate output from the measurement matrix B.

The P-NN 400 is configured to determine a third intermediate output by processing the sparse image 404 using a third subset of layers of the P-NN 400. The third subset of layers of the P-NN 400 includes the convolutional layer 412, the self-attention layer 416, and the convolutional layer 420, which are configured to determine the third intermediate output from the sparse image 404.

The self-attention layer 416 is configured to determine a query f_{q}(X), a key fₖ(X), and a value fᵥ(X) by applying the respective convolution layers 604, 608, 612 to an input matrix X to the self-attention layer 416. The self-attention layer 416 is configured to determine an attention map A based on the query f_{q}(X) and the key fₖ(X). The self-attention layer 416 is configured to determine a preliminary output matrix O based on the attention map A and the value fᵥ(X). Finally, the self-attention layer 416 is configured to determine a final output matrix Y by combining the preliminary output matrix O with the input matrix X.

The P-NN 400 is configured to determine a concatenated output by concatenating the first intermediate output from the first subset of layers, the second intermediate output from the second subset of layers, and the third intermediate output from the third subset of layers, using the concatenation layer 440. Based on the concatenated output, the P-NN 400 is configured to determine the position of the target device 1110 using a fourth subset of layers of the P-NN 400. The fourth subset of layers of the P-NN 400 includes the fully connected layers 444 and 448 and a final layer 452 configured to determine the position of the target device 1110.

In some embodiments, the final layer 452 is configured to determine a classification output indicating a respective zone from a plurality of zones within which the target device 1110 is positioned within the environment. Alternatively, in some embodiments, the final layer 452 is configured to determine a regression output indicating an estimated coordinate position at which the target device 1110 is positioned within the environment.

Once the data fusion center 1150 has determined the position of the target device 1110, it may perform several downstream actions that are tailored to the particular application. For example, the determined position can be transmitted back to the target device 1110 for usage thereat. As another example, the determined position can be used by a vehicle so that it can update its state or control a vehicle subsystem, such as a security system or locks of the vehicle. Alternatively, the data fusion center 1150 may directly command actuators in an autonomous platform (e.g., a drone or robotic forklift) through a control interface thereof. In buildings, the position estimate can be relayed to a central controller to trigger IoT devices or security protocols based on the determined position. In industrial settings, the determined position may also be used by asset-tracking subsystems to update inventory databases in real time.

### Numerical Evaluation

In this section, we provide a set of numerical experiments to evaluate P-NN. The results show that our feature set provides competitive (or better) performance against the PDP-based baselines in high (or low) SNR regimes, and thus achieves a desirable performance-complexity tradeoff.

We conduct a set of numerical experiments to evaluate the effectiveness of our proposed features and the performance of P-NN. For the geographical layout, we consider a rectangular sensor space of dₓ=6 m, d_{y}=3 m, and d_{z}=2 m and a cylindrical target space of dᵣ=10 m and dₕ=4 m. We place M=12 sensors inside the sensor space to resemble the shape of a vehicle. Note that we use such a placement of sensors to represent a mobile environment for WP. For wireless channels, we consider two scenarios from the IEEE UWB standard: residential (RES) and outdoor (OUT) environments. For each scenario, we generate L randomly located channel clusters using a Poisson distribution of mean L̅ and set Kₗ=6 for all l. Table II shows simulation parameters for residential (RES) and outdoor (OUT) environments, where numerical values for the scenario-dependent parameters L̅,

$${σ}_{s}^{2} , {σ}_{c}^{2}$$

are given

TABLE II

| Scenario | L̅ | σₛ² | σ_{c}² |
|---|---|---|---|
| RES | 3 | 3 dB | 3 dB |
| OUT | 12 | 3 dB | 1 dB |

For each channel path, we generate μ_{m,l,k} using the mean μ̅=0.67 dB and variance \tilde{μ}=0.28 dB. For the temporal parameters, we set κ=1.5 ns, Γ=25 ns, γ=5 ns. Regarding the path loss, we set ξ=2 and consider P̅ₘ=−45 dBm and d̅ₘ=1 m for all sensors. For signal transmission and processing steps, we assume W=2 GHz, T_{f}=200 ns, and T_{g}=2 ns to have N_{b}=100. For each sensor m, we define the SNR as

$$𝔼 [ {β}_{m , 0 , 0} ] / {σ}_{n , m}^{2} ,$$

where the expectation is over the target space. To impose the NLOS condition, for each scenario, we remove all existing LOS paths by setting a_{m,0,k}=0 for all m and k. For the KL divergence estimation, we use u=30.

For training data, we randomly generate D=30,000 target locations inside the target space. For each target location, the feature [symbol] is generated and paired with a label ρᵢ. To train models, we use an Adam optimizer with a learning rate of 0.001. Training is performed over 50 epochs with a random batch size of 256. For the testing phase, 6,000 target locations are randomly generated, and a pair of [symbol] and ρ is obtained for each location. To evaluate the classification performance, we predict \hat{ρ} for each location in the testing data and compare it with ρ. We consider that a target is correctly positioned only if \hat{ρ}=ρ. For statistical significance, the result was obtained after averaging over 20 independent simulation runs and five different scenarios. FIG. 13 shows a plot 1300 of an illustration of training sets (left) and a plot 1310 of testing sets (right) in a 2D plane. For the training set, the same color implies the same classification zone. For the testing set, redder color indicates lower classification accuracy.

Effectiveness of the proposed features: First, we evaluate the effectiveness of our proposed features. For comparison, we consider two intuitive baseline approaches to reduce the feature size: (i) taking power measurements from the first F temporal bins (i.e., n=0, 1, . . . , F−1) and (ii) taking power measurements from F randomly selected bins. We use three classic supervised learning algorithms: fully connected layers (FCL) with three 50-neuron hidden layers, SVM for one-to-rest multi-class classification, and KNN with k=11.

Table III shows a comparison in 8-zone classification performance by different ways of selecting features. Performance is evaluated by several algorithms: fully connected layers (FCL) with three 50-neuron hidden layers, support vector machine (SVM) for one-to-rest multi-class classification, and k-nearest neighbors (KNN) with k=11.

TABLE III

| | | Proposed | | | First | | | Random | | |
|---|---|---|---|---|---|---|---|---|---|---|
| Channel | F | FCL | SVM | KNN | FCL | SVM | KNN | FCL | SVM | KNN |
| LOS 15 dB | 5 | 89.6 | 88.1 | 63.4 | 44.1 | 42.8 | 42.6 | 35.5 | 33.7 | 29.1 |
| | 10 | 91.1 | 89.6 | 68.9 | 71.8 | 70.3 | 62.6 | 49.2 | 46.4 | 33.1 |
| | 15 | 91.1 | 89.4 | 69.4 | 87.1 | 84.3 | 70.9 | 58.5 | 55.9 | 35.2 |
| | 20 | 90.1 | 89.4 | 69.2 | 88.7 | 86.2 | 66.4 | 65.4 | 61.6 | 36.6 |
| | N_{b} | 91.1 | 89.7 | 67.3 | 91.1 | 89.7 | 67.3 | 91.1 | 89.7 | 67.3 |
| LOS 5 dB | 5 | 67.9 | 62.3 | 45.7 | 39.3 | 28.9 | 36.9 | 21.1 | 16.6 | 20.2 |
| | 10 | 69.4 | 63.4 | 45.4 | 58.5 | 46.7 | 48.0 | 26.9 | 21.2 | 22.7 |
| | 15 | 69.6 | 63.7 | 44.2 | 67.7 | 55.7 | 49.5 | 31.2 | 25.6 | 23.9 |
| | 20 | 70.0 | 64.1 | 43.6 | 70.5 | 60.8 | 49.3 | 35.5 | 28.6 | 24.7 |
| | N_{b} | 71.2 | 64.3 | 43.9 | 71.2 | 64.3 | 43.9 | 71.2 | 64.3 | 43.9 |
| NLOS 15 dB | 5 | 79.9 | 73.8 | 50.3 | 12.5 | 12.4 | 12.9 | 29.0 | 23.0 | 27.2 |
| | 10 | 81.7 | 76.0 | 53.6 | 14.7 | 14.2 | 15.1 | 38.9 | 31.4 | 30.9 |
| | 15 | 82.1 | 75.9 | 53.7 | 27.3 | 23.7 | 26.5 | 46.0 | 37.4 | 33.1 |
| | 20 | 82.2 | 75.5 | 53.6 | 45.7 | 36.5 | 39.7 | 51.3 | 43.6 | 37.4 |
| | N_{b} | 82.4 | 75.8 | 52.7 | 82.4 | 75.8 | 52.7 | 82.4 | 75.8 | 43.6 |
| NLOS 5 dB | 5 | 47.4 | 41.0 | 29.1 | 12.5 | 12.6 | 12.6 | 16.3 | 14.7 | 16.4 |
| | 10 | 48.4 | 41.5 | 27.3 | 13.8 | 13.3 | 13.8 | 19.3 | 16.2 | 17.2 |
| | 15 | 49.0 | 42.1 | 26.7 | 22.5 | 16.8 | 20.6 | 21.9 | 18.0 | 17.4 |
| | 20 | 49.0 | 42.5 | 26.3 | 34.0 | 26.2 | 24.9 | 23.9 | 19.7 | 18.3 |
| | N_{b} | 50.2 | 42.3 | 27.1 | 50.2 | 42.3 | 27.1 | 50.2 | 42.3 | 27.1 |

In Table III, we summarize the classification performance obtained with N_{z}=8 over a number of different channel conditions. Note that F=N_{b} refers to using full PDP for the features. From the table, we make the following observations. First, taking random F measurements yields low performance in general. This implies that there is a certain set of measurements located across the N_{b} temporal bins that are important for WP. Second, taking the first F bins exhibits a significant performance gap between LOS and NLOS channels. Since taking the earliest powers is suitable for capturing the LOS path signals, the performance drastically drops for the NLOS channel condition. Meanwhile, using our feature set yields both high and robust performance across the channel conditions and algorithms. Also, for all cases, taking the largest powers can reach the peak performance (i.e., performance with full PDP) within F=20. Particularly, the performance begins to saturate after F=10, with a maximum increase of 0.6% in classification accuracy beyond this point. Therefore, we verify that our proposed feature selection method is able to effectively locate the temporal bins that are significant for WP and reach near-maximum performance with much lower feature size. In other words, our methodology yields improvements in the performance-complexity tradeoff for WP.

In FIG. 14, we provide a classification performance vs. feature size plot for various channel conditions. Particularly, FIG. 14 shows a plot 1400 of classification performance vs. feature size plot of different feature size reduction methods. Solid and dashed lines indicate LOS and NLOS conditions, respectively. Performance is normalized to the one obtained using full PDP and averaged over three different classification algorithms: FCL, KNN, and SVM. Feature size is normalized to N_{b}=100. The proposed features provide robust performance. To focus on evaluating the performance-efficiency tradeoff, we normalize both the performance and feature size to the case of using full PDP. From the figure, we see that using the proposed features can achieve performance close to one (i.e., same as using full PDP) even when the feature size is reduced to 10%. Unlike other baselines, which show varying performance depending on the channel conditions, our feature set demonstrates its robustness by keeping the performance high under all conditions.

Table IV shows classification and runtime performance attained from using different power measurement schemes: energy detector (ED) and matched filter (MF). Presented runtime values include only the power measurement steps to obtain εₘ from rₘ(t). Improved performance from MF comes at the cost of having increased runtime.

TABLE IV

| | | Classification Accuracy | | | | |
|---|---|---|---|---|---|---|
| | | Channel | | | | |
| | | LOS | | NLOS | | |
| SNR | | 15 dB | 5 dB | 15 dB | 5 dB | Runtime (s) |
| ED | F = 5 | 89.6 | 67.9 | 79.9 | 47.4 | 36.8 |
| | F = 15 | 91.1 | 69.6 | 82.1 | 49.0 | |
| | F = N_{b} | 91.1 | 71.2 | 82.4 | 50.2 | |
| MF | F = 5 | 90.9 | 84.4 | 85.4 | 67.0 | 65.7 |
| | F = 15 | 92.9 | 85.7 | 87.1 | 68.1 | |
| | F = N_{b} | 92.8 | 86.1 | 87.4 | 69.1 | |

Performance with different power measurement schemes: Here, we evaluate the classification performance of our proposed features when different power measurement schemes are employed: energy detector (ED) and matched filter (MF). Unlike ED, MF utilizes a signal template and correlates across the received signal to achieve higher SNRs for the power measurement. Note that MF requires the Nyquist rate (i.e., the sampling rate of 2W) and an extra convolution step, and therefore yields significantly higher implementation complexities as compared to ED, which operates on a sub-Nyquist rate of

$$\frac{1}{{T}_{g}} .$$

With our simulation sewing (i.e., W=2 GHz and T_{g}=2 ns), MF requires an eight times faster sampling rate than ED, which may be prohibitive for low-cost sensors.

In Table IV, we show the classification performance obtained over different channel conditions and the values of F. Similar to the result shown in Table III, for both ED and MF, our features with lower values of F can approach the performance attained when using full PDP. We observe that the overall performance improves with MF as it relies on the correlation step to increase the SNR after filtering. Note that a more noticeable improvement is shown for both low SNR and NLOS cases, verifying the effectiveness of MF on harsh channel conditions.

Next, to evaluate the performance-complexity tradeoff between ED and MF, we provide the total runtime that takes for each scheme to acquire the PDP vector εₘ for the entire training data. We see that MF takes almost double the time ED takes to measure the power of received signals, as MF involves the additional convolution step. While MF yields better performance than ED, ED shows a clear advantage in both implementation and computational complexities, and therefore, constitutes a desirable power measurement scheme in mobile applications.

Ablation study on P-NN: Next, we evaluate the P-NN by performing an ablation study on three key components: directing processing (DP) of measurement matrices, spatial processing on a sparse image (SI), and a self-attention layer (SA). Table V shows an ablation study on the architecture of P-NN in terms of classification performance. Considered components are direct processing (DP) of measurement matrices, sparse image (SI) processing, and a self-attention layer (SA). Each component's effectiveness is articulated over different channel conditions.

TABLE V

| | N_{z} | | | | | | | |
|---|---|---|---|---|---|---|---|---|
| | 8 | | | | 32 | | | |
| | Channel | | | | | | | |
| | LOS | | NLOS | | LOS | | NLOS | |
| SNR | 15 dB | 5 dB | 15 dB | 5 dB | 15 dB | 5 dB | 15 dB | 5 dB |
| DP | 89.37 | 60.41 | 76.60 | 33.87 | 72.53 | 38.29 | 60.85 | 15.68 |
| SI | 93.42 | 69.01 | 86.02 | 41.15 | 83.09 | 47.65 | 70.24 | 20.74 |
| DP + SI | 93.61 | 69.52 | 86.98 | 42.13 | 83.89 | 49.66 | 71.93 | 22.40 |
| SI + SA | 94.21 | 70.12 | 86.62 | 41.72 | 83.93 | 48.12 | 70.94 | 21.65 |
| DP + SI + SA | 94.51 | 70.62 | 87.43 | 42.66 | 84.33 | 49.85 | 72.62 | 23.17 |

In Table V, we provide the classification results obtained by five different combinations of the components, where various channel conditions were applied for comprehensive analysis. From the table, we make several observations. First, among the three network components we evaluate, SI provides the most improvement (about 10% increase as compared to the DP-only case) in the classification performance. For all cases, DP+SI+SA alone yields the highest performance, which implies that each component contributes to the training/learning ability of P-NN in a cooperative manner. This is also confirmed by the pattern where a different combination shows a different degree of improvement in the performance. For instance, DP is shown to be more effective against harsh channel conditions as it brings noticeable performance improvement with low SNR and/or NLOS conditions. On the other hand, SA shows its effectiveness when the channel condition is fairly good (i.e., with high SNR and/or LOS condition). Hence, the P-NN is effectively trained by our features and shows improved classification performance by taking different input formats and processing steps.

Impact of feature size selection: Next, we demonstrate the effectiveness of our feature size selection method described elsewhere herein. Table VI shows zone classification rates (in percent) of P-NN with different values of F. The rates achieved using F* in equation (21) are indicated in bold. We set ϵ=0.8 (or 0.6) for the LOS (or NLOS) channel scenarios. The value of F that reaches the peak performance varies by scenario.

TABLE VI

| Scenario # | SNR | F = 4 | F = 5 | F = 6 | F = 7 | F = 8 | F = 9 | F = 10 |
|---|---|---|---|---|---|---|---|---|
| LOS #3 | 15 dB | 91.21 | 91.59 | 92.07 | 92.35 | 92.51 | 92.67 | 92.82 |
| LOS #4 | | 88.21 | 89.42 | 90.11 | 90.51 | 90.88 | 90.84 | 90.89 |
| NLOS #3 | | 76.31 | 77.25 | 77.79 | 77.80 | 78.14 | 78.25 | 78.41 |
| NLOS #4 | | 69.67 | 72.30 | 74.48 | 75.59 | 76.00 | 76.79 | 77.24 |
| LOS #3 | 5 dB | 68.48 | 69.67 | 70.32 | 70.71 | 71.03 | 71.14 | 71.24 |
| LOS #4 | | 69.71 | 70.50 | 70.92 | 71.45 | 72.09 | 72.24 | 72.37 |
| NLOS #3 | | 44.19 | 44.64 | 44.94 | 45.23 | 45.12 | 45.39 | 45.57 |
| NLOS #4 | | 49.22 | 49.26 | 49.46 | 49.80 | 50.00 | 50.23 | 50.15 |

In Table VI, we provide the performance (in zone classification rate) of the P-NN using different values of F over various channel conditions. We set the search range of F to [4,10] since we gain no significant improvement in performance on further increasing F for this simulation setting, as shown in Table III. To clarify, other scenarios may produce optimal F* that are outside of this range; it will vary according to the shape of sensor/target space, the number/location of channel clusters, the SNR, and other conditions that may impact the properties of the power delay profile. For evaluation purposes, here we are training the P-NN and obtaining its test performance for each value of F, though as discussed elsewhere herein, F* can be obtained without repeatedly training the network. We observe that, for all channel conditions, the value of F that approaches the peak performance varies by scenario. This implies that the desirable feature size for conducting accurate WP is scenario-specific and depends on the condition of channel propagation induced by channel clusters. For each row, the numerical value in bold indicates the performance obtained using F* from our feature size selection method. We observe that training the P-NN with F* can maintain high classification performance with a relatively lower feature size. In other words, F* becomes the point where the marginal increase in classification performance is noticeably reduced. This verifies that taking the largest power and time measurements constitutes minimum description features for navigating the performance-complexity tradeoff. Overall, our feature size selection can adaptively determine the dimensions of our features and lead to high WP performance.

Classification performance of P-NN: Now we compare the performance of P-NN with the baselines, for which we consider CNN-LE and NN-LCS. CNN-LE is the WP algorithm that takes PDP as input features and utilizes a set of convolutional and max-pooling layers to perform localization. On the other hand, NN-LCS takes both TOA and RSS measurements and uses FC layers to obtain a set of distance estimation vectors. Then, the least-squares estimation is applied to estimate the target location. Compared to CNN-LE, which uses the feature of size MN_{b}, NN-LCS only takes 2M measurements. We consider CNN-LE and NN-LCS as our baselines since they respectively adopt a similar channel model and positioning layout as our work, from which we can provide an objective evaluation and comparison. For the baselines, we determine the zone classification output based on the coordinates predicted by the algorithms.

First, we provide classification rate vs. SNR plots for the residential scenario in FIG. 15 and FIG. 16. Particularly, FIG. 15 shows a plot 1500 of performance vs. SNR of different WP algorithms with residential LOS channels. Feature sizes for CNN-LE and NN-LCS are 1400 and 24, respectively. The feature size for the proposed ranges from 72 to 240. The performance advantage of P-NN becomes noticeable in low SNRs. FIG. 16 shows a plot 1600 of performance vs. SNR of different WP algorithms with residential NLOS channels. Feature sizes for CNN-LE and NN-LCS are 1400 and 24, respectively. The feature size for the proposed ranges from 72 to 240. The performance advantage of P-NN becomes noticeable in low SNRs.

For P-NN, we determine F* from a range [4,10]. We observe that the performance of NN-LCS in both plots is significantly lower, demonstrating the difficulty of achieving good WP performance from a small-sized feature. Compared to NN-LCS, both CNN-LE and P-NN provide better performance. Especially in low SNR, P-NN outperforms CNN-LE as it discards the measurements from noise-only bins, the power of which become greater with low SNR, and thus prevents them from being used in the network training.

In FIG. 17 and FIG. 18, we provide performance vs. SNR plots for the outdoor scenario. Particularly, FIG. 17 shows a plot 1700 of performance vs. SNR of different WP algorithms with outdoor LOS channels. Feature sizes for CNN-LE and NN-LCS are 1400 and 24, respectively. The feature size for the proposed ranges from 72 to 240. FIG. 18 shows a plot 1800 of performance vs. SNR of different WP algorithms with outdoor NLOS channels. Feature sizes for CNN-LE and NN-LCS are 1400 and 24, respectively. The feature size for the proposed P-NN ranges from 72 to 240.

We observe that the higher performance is achieved in the outdoor scenario since there are more channel clusters present in the channel space, which provides more channel propagation and signals for the network to utilize. However, the overall tendency is the same as the residential scenario, where P-NN exhibits the best classification performance. Given that the performance is competitive between CNN-LE and P-NN (i.e., similar or better performance is achieved depending on the SNR level), the P-NN, which takes only the largest measurements from PDP, takes an advantage in the performance-complexity tradeoff.

Accuracy range vs. input dimension: To directly demonstrate the advantage of the P-NN in the performance-complexity tradeoff, we provide box plots showing the range of classification rates obtained by different WP algorithms and the number of feature dimensions in FIG. 19. Particularly, FIG. 19 shows plots 1900, 1910 of classification rates obtained with 10, 15, and 20 dB SNRs by different WP algorithms (left) and the number of dimensions (right). For P-NN, we consider F∈{4,7,10}, leading to the three middle dimensions on the right. We observe that NN-LCS has the lowest dimension, but the performance is low and exhibits a high variance. CNN-LE exhibits a steady and high classification rate, but such a performance is achieved at the cost of utilizing high-dimensional features. P-NN using our proposed feature set shows a performance similar to that of CNN-LE at relatively low feature dimensions. This result demonstrates that our feature set can provide positioning performance that is much more complexity-efficient.

Regression performance of P-NN: Additionally, we evaluate the regression performance of the P-NN in terms of root mean squared error (RMSE) and compare it with other baselines. Instead of using the classification layer (i.e., N_{z}-sized layer with softmax activation), we apply a regression layer that has three neurons with linear activation for estimating 3D coordinates. If we use [symbol] =[\hat{x}, ŷ, \hat{z}]^{T} to denote the estimated target location of the P-NN, we compute the RMSE performance using the expression

$$RMSE = \sqrt{𝔼 [ {( \hat{x} - x )}^{2} + {( \hat{y} - y )}^{2} + {( \hat{z} - z )}^{2} ]} .$$

FIG. 20 shows a plot 2000 of RMSE performance vs. SNR of different WP algorithms with residential channels. Feature sizes for CNN-LE and NN-LCS are 1400 and 24, respectively. The feature size for the proposed P-NN ranges from 72 to 240. We provide an RMSE versus SNR plot of different WP algorithms evaluated with residential LOS and NLOS channels. From the figure, we make the following observations. First, for 10 dB, 15 dB, and 20 dB SNRs, the relative performance across the algorithms is similar to the ones shown in FIG. 15 and FIG. 16, where we evaluate the classification performance. Hence, the P-NN provides a highly efficient performance-complexity tradeoff for the regression task as well. Second, for 0 dB and 5 dB SNRs, the performance of NN-LCS relative to CNN-LE and P-NN is better than what is shown in classification performance. This implies that, for a regression task, processing the features in an image format is not an effective approach since it is difficult to convey spatial correlation across heavily corrupted measurements from low SNR. In such a case, providing only the most dominant features in a numerical format (e.g., RSS and TOA values from each sensor) may achieve better performance. We see that, regardless of SNR levels, the P-NN is able to achieve high performance since its architecture adopts both ways of processing the features.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general-purpose or special-purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data that cause a general-purpose computer, special-purpose computer, or special-purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

What is claimed is:

1. A method for determining a position of a target device using a wireless positioning system, the method comprising:
receiving, with a processor, a plurality of data sets from a plurality of sensors of the wireless position system that measured a radio impulse signal transmitted by the target device, the plurality of data sets including a respective data set from each respective sensor in the plurality of sensors, each respective data set including a subset of elements from a respective power-delay profile vector, the respective power-delay profile vector having been determined based on the radio impulse signal measured at the respective sensor; and
determining, with the processor, a position of the target device by processing the plurality of data sets using a neural network.

2. The method according to claim 1, the determining the position of the target device further comprising:
forming a first measurement matrix from the plurality of data sets;
forming a second measurement matrix from the plurality of data sets;
forming a sparse image from the plurality of data sets; and
determining the position of the target device by processing the first measurement matrix, the second measurement matrix, and the sparse image using the neural network.

3. The method according to claim 2, wherein the subset of elements from the respective power-delay profile vector includes a predetermined number of largest elements from the power-delay profile vector.

4. The method according to claim 3, wherein the subset of elements from the respective power-delay profile vector are ordered largest to smallest within each respective data set.

5. The method according to claim 3, the forming the first measurement matrix further comprising:
forming the first measurement matrix having dimensions M x F, where M is a total number of sensors in the plurality of sensors and F is the predetermined number, the first measurement matrix including as values the subset of elements from the respective power-delay profile vector.

6. The method according to claim 3, wherein each respective data set further includes temporal indices corresponding to the subset of elements from the respective power-delay profile vector.

7. The method according to claim 6, the forming the second measurement matrix further comprising:
forming the second measurement matrix having dimensions M×F, where M is a total number of sensors in the plurality of sensors and F is the predetermined number, the second measurement matrix including as values the temporal indices corresponding to the subset of elements from the respective power-delay profile vector.

8. The method according to claim 6, the forming the sparse image further comprising:
forming the sparse image having dimensions M×N_{b}, where M is a total number of sensors in the plurality of sensors and N_{b} is a total number of temporal indices of the radio impulse signal measured at each sensor in the in the plurality of sensors, the sparse image including the subset of elements from the respective power-delay profile vector as sparse values in the sparse image, each other value in the sparse image being zero.

9. The method according to claim 3, wherein the predetermined number is determined prior to deployment of the wireless positioning system and is determined depending on noise conditions and line-of-sight conditions of an environment in which the wireless positioning system is deployed.

10. The method according to claim 2, the determining the position of the target device further comprising:
normalizing the plurality of data sets,
wherein the first measurement matrix, the second measurement matrix, and the sparse image are formed using the normalized plurality of data sets.

11. The method according to claim 2, the determining the position of the target device further comprising:
determining a first intermediate output by processing the first measurement matrix using a first subset of layers of the neural network;
determining a second intermediate output by processing the second measurement matrix using a second subset of layers of the neural network;
determining a third intermediate output by processing the sparse image using a third subset of layers of the neural network;
determining a concatenated output by concatenating the first intermediate output, the second intermediate output, and the third intermediate output; and
determining the position of the target device by processing the concatenated output using a fourth subset of layers of the neural network.

12. The method according to claim 11, wherein:
the first subset of layers of the neural network includes at least one convolutional layer configured to determine the first intermediate output from the first measurement matrix; and
the second subset of layers of the neural network includes at least one convolutional layer configured to determine the second intermediate output from the second measurement matrix.

13. The method according to claim 11, wherein the third subset of layers of the neural network includes at least one convolutional layer and a self-attention layer configured to determine the third intermediate output from the sparse image.

14. The method according to claim 13, wherein the self-attention layer is configured to:
determine a query, a key, and a value by applying respective convolution layers to an input matrix to the self-attention layer;
determine an attention map based on the query and the key;
determine a preliminary output matrix based on the attention map and the value; and
determine a final output matrix by combining the preliminary output matrix with the input matrix.

15. The method according to claim 11, wherein the fourth subset of layers of the neural network includes at least one fully connected layer configured to determine the position of the target device.

16. The method according to claim 11, the determining the position of the target device further comprising:
determining a classification output indicating a respective zone from a plurality of zones within which the target device is positioned within an environment.

17. The method according to claim 11, the determining the position of the target device further comprising:
determining a regression output indicating an estimated coordinate position at which the target device is positioned within an environment.

18. The method according to claim 1 further comprising:
measuring, with each respective sensor of the plurality of sensors, the radio impulse signal received from the target device;
determining, with each respective sensor of the plurality of sensors, the respective power-delay profile vector based on the radio impulse signal measured at the respective sensor; and
determining, with each respective sensor of the plurality of sensors, the respective data set including the subset of elements from the respective power-delay profile vector.

19. The method according to claim 18, the determining the respective data set further comprising:
reordering the respective power-delay profile vector from largest to smallest elements;
identifying the subset of elements from the respective power-delay profile vector as a predetermined number of largest elements from the power-delay profile vector; and
forming the data set including the subset of elements from the respective power-delay profile vector and temporal indices corresponding to the subset of elements from the respective power-delay profile vector.

20. The method according to claim 1, wherein the plurality of sensors are installed throughout a vehicle or a building.
